(19) United States
(12) Patent Application Publication
(10) Pub. No.: US 2010/0027041 A1
(43) Pub. Date: Feb. 4, 2010

(54) IMAGE FORMING APPARATUS, INFORMATION PROCESSING APPARATUS, DATA PROCESSING METHOD, AND STORAGE MEDIUM STORING PROGRAM

(75) Inventor: Shoichi Kanno, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/510,556

(22) Filed: Jul. 28, 2009

(30) Foreign Application Priority Data
Aug. 4, 2008 (JP) 2008-200653

(51) Int. Cl. G06F 3/12

(52) U.S. Cl. 358/1.13

(57) ABSTRACT

An image forming apparatus including a plurality of functions corresponding respectively to a plurality of device drivers includes a communication unit configured to communicate with an information processing apparatus according to a universal serial bus standard, a storage unit corresponding to a storage class defined by the universal serial bus standard, a determination unit configured to determine whether device information corresponding to one function among the plurality of functions has been received from the information processing apparatus, and a sending unit configured to, if the determination unit determines that the device information has been received, send information based on the device information to the information processing apparatus via the communication unit.

### BACKGROUND OF THE INVENTION

1. Field of the Invention

The present invention relates to data processing in an information processing apparatus which can communicate with an image forming apparatus having a plurality of device drivers.

2. Description of the Related Art

In a multifunction peripheral mounted with a scanner apparatus and a plurality of page-description language (PDL) printing apparatuses, a composite universal serial bus (USB) may be used as a connection mode with a client computer (hereinafter, referred to as a computer). Namely, since devices having a system mode in which an information processing apparatus and a multifunction peripheral are connected via a USB cable can have a plurality of functions without having a USB hub in the device, such devices mainly tend to be employed in low-cost multifunction devices.

If a composite USB device is connected to the client computer and plug and play is executed, all of the logical devices defined in the device successively appear.

Therefore, unless all of the drivers for the logical device are installed on the client computer, an unknown device will remain in the client computer.

Further, when the multifunction apparatus is connected to the information processing apparatus, if a plurality of PDL drivers of a device mounted with a plurality of PDLs is installed on the information processing apparatus, a plurality of printer icons is displayed on the information processing apparatus.

Furthermore, for a beginner user, if a plurality of printer icons is displayed on the information processing apparatus, the user may become confused as to which PDL device (printer icon) to use.

Japanese Patent Application Laid-Open No. 2005-258661 discusses a method for selecting a desired PDL from such a device mounted with a plurality of PDLs. In Japanese Patent Application Laid-Open No. 2005-258661, it is described that, as a result of adding a PDL option, a command (CMD) defined in Institute of Electrical and Electronics Engineers 1284 (IEEE 1284) is referenced by plug and play to correctly operate plug and play in an environment having a plurality of PDLs.

### SUMMARY OF THE INVENTION

According to an aspect of the present invention, an image forming apparatus including a plurality of functions corresponding respectively to a plurality of device drivers includes a communication unit configured to communicate with an information processing apparatus according to a universal serial bus standard, a storage unit corresponding to a storage class defined by the universal serial bus standard, a determination unit configured to determine whether device information corresponding to one function among the plurality of functions has been received from the information processing apparatus, and a sending unit configured to, if the determination unit determines that the device information has been received, send information based on the device information to the information processing apparatus via the communication unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a printing system, which includes an information processing apparatus and an image forming apparatus, according to an exemplary embodiment of the present invention.

FIG. 2 is a schematic diagram illustrating data processing steps in the printing system illustrated in FIG. 1.

FIG. 3 illustrates an ordinary interface configuration of a multifunction peripheral illustrated in FIG. 1.

FIG. 4 is a flowchart illustrating data processing in the information processing apparatus according to an exemplary embodiment of the present invention.

FIG. 5 illustrates a configuration of a driver installation module from an image forming apparatus according to an exemplary embodiment of the present invention.

FIG. 6 illustrates an example of a user interface which can be displayed by the computer illustrated in FIG. 1.

FIG. 7 illustrates a plug and play scheme in a typical computer system.

FIG. 8 illustrates an interface configuration of the multifunction peripheral illustrated in FIG. 1.

FIG. 9 illustrates an interface configuration of the multifunction peripheral illustrated in FIG. 1.

FIG. 10 illustrates an interface configuration of the multifunction peripheral illustrated in FIG. 1.

FIG. 11 illustrates an example of a user interface which can be displayed by the computer illustrated in FIG. 1.

FIG. 12 is a flowchart illustrating an example of data processing in the image forming apparatus according to an exemplary embodiment of the present invention.

FIG. 13 illustrates an example of device configuration data in the multifunction peripheral illustrated in FIG. 1.

FIG. 14 is a flowchart illustrating an example of data processing in the image forming apparatus according to an exemplary embodiment of the present invention.

FIG. 15 is a flowchart illustrating an example of data processing in the information processing apparatus according to an exemplary embodiment of the present invention.

FIG. 16 illustrates an example of a user interface which is displayed on the display illustrated in FIG. 1.

FIG. 17 illustrates an example of a user interface which is displayed on the display illustrated in FIG. 1.

FIG. 18 illustrates an example of a user interface which is displayed on the display illustrated in FIG. 1.

FIG. 19 illustrates an example of a user interface which is displayed on the display illustrated in FIG. 1.

FIG. 20 is a flowchart illustrating an example of a data processing procedure in the information processing apparatus according to an exemplary embodiment of the present invention.

FIG. 21 illustrates a composite USB configuration in the image forming apparatus according to an exemplary embodiment of the present invention.

FIG. 22 is a flowchart illustrating a data processing procedure in the image forming apparatus according to an exemplary embodiment of the present invention.

FIG. 23 is a flowchart illustrating an example of a data processing procedure in the information processing apparatus according to an exemplary embodiment of the present invention.

FIG. 24 is a flowchart illustrating an example of a data processing procedure in the information processing apparatus according to an exemplary embodiment of the present invention.

### DETAILED DESCRIPTION OF THE EMBODIMENTS

Various exemplary embodiments, features, and aspects of the invention will be described in detail below with reference to the drawings.

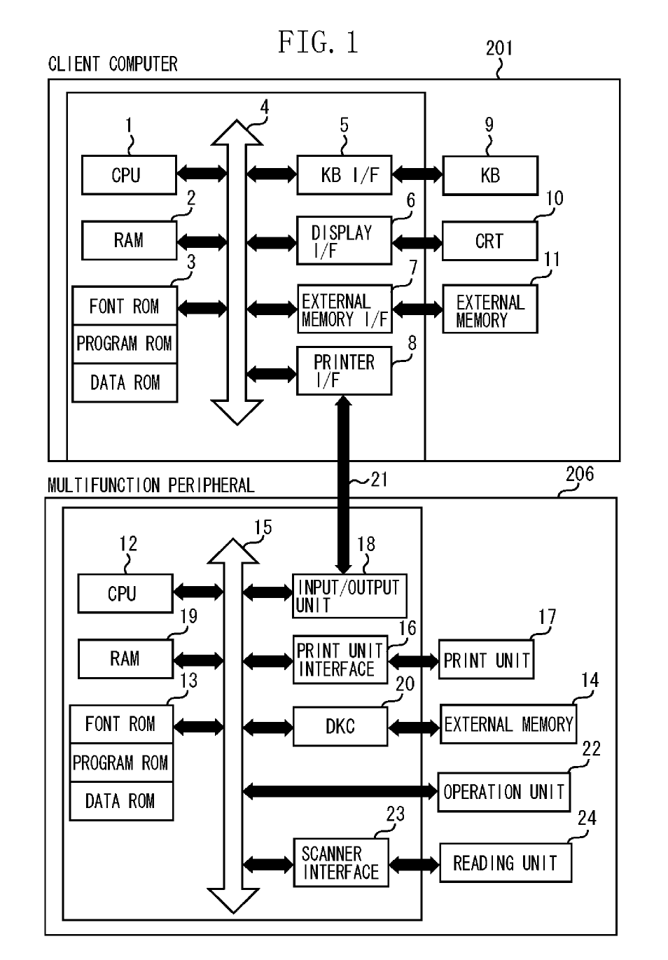

FIG. 1 is a block diagram illustrating a configuration of a printing system, which includes an information processing apparatus and an image forming apparatus, according to an exemplary embodiment of the present invention. In this printing system, the information processing apparatus and the image forming apparatus are connected by a two-way communication-capable USB interface.

Further, when connected to a multifunction peripheral via the USB interface, the information processing apparatus according to an exemplary embodiment of the present invention manages a memory included in the multifunction peripheral so that it can be referenced as its own memory. The information processing apparatus is configured so that it can recognize the memory included in the multifunction peripheral as a storage unit.

This storage unit corresponds to the below-described storage device. In the present exemplary embodiment, an example is illustrated which is configured using an external memory, random access memory (RAM) and the like included in the multifunction peripheral. The storage unit is configured so that it can store print data transferred from the information processing apparatus or device configuration data corresponding to a device driver that is selected by the user. Device configuration data is an example of device information.

The multifunction peripheral includes a plurality of device drivers, for example, a printer driver for processing page description language data. Processing for configuring the driver information is performed based on the device configuration data stored in the storage unit acquired from the information processing apparatus.

Further, in the device configuration data, identification information, which is generated by a predetermined pseudorandom number such as that described below, for specifying an operating system (OS) of the information processing apparatus is set. In the present exemplary embodiment, the multifunction peripheral performs monitoring processing by recognizing whether the USB cable functioning as the USB interface is in a connected state or a non-connected state.

In the present exemplary embodiment, an example is illustrated of a wired USB interface as the interface. However, the present exemplary embodiment can also be applied to a printing system connected by a wireless interface. Similarly, while a PDL driver is illustrated as an example for the device driver, the present exemplary embodiment is not limited to a PDL driver. The scope of the present exemplary embodiment also includes various other drivers, such as a scanner driver for performing original document reading, a facsimile driver for performing facsimile sending and receiving processing and the like. The device driver is installed by a plug and play function of the OS based on the configuration of the device, which is stored in the below-described storage unit of the device.

In FIG. 1, in a client computer (computer) 201, a CPU 1 loads the operating system (OS) stored in an external memory 11 into a RAM 2. Then, the CPU 1 performs various types of information processing by loading a predetermined application into the RAM 2.

A read-only memory (ROM) 3 executes document processing in which graphics, images, characters, tables (including spreadsheets, etc.) and the like are intermixed based on a document processing program stored in a program ROM or the external memory 11. The CPU 1 controls all of the devices connected to a system bus 4. The RAM 2 functions as a main memory and a work area for the CPU 1.

The OS, which is a control program of the CPU 1, is stored in the program ROM of the ROM 3 or in the external memory 11. Font data to be used during the above-described document processing is also stored in the program ROM of the ROM 3 or in the external memory 11. Further, various other data to be used during the above-described document processing is also stored in the program ROM of the ROM 3 or the in external memory

A keyboard interface (I/F) 5 controls key inputs from a keyboard 9 or a not-illustrated pointing device. A display I/F 6 controls display of a display 10.

An external memory I/F 7 controls access to the external memory 11, which stores a boot program, various applications, font data, user files, edit files, printer drivers, and the like. Examples of the external memory 11 include a hard disk (HD), flexible disk (FD), compact disc (CD), and the like.

A printer I/F 8 is connected to the multifunction peripheral 206 via a predetermined two-way interface (USB) 21, and executes communication control processing with the multifunction peripheral 206. The CPU 1 executes outline font rasterization processing to a display information RAM set in the RAM 2, for example, which enables what you see is what you get (WYSIWYG) on the display 10.

The CPU 1 opens various registered windows based on a command instructed by a not-illustrated mouse cursor or the like on the display 10, and executes various data processing. When the user executes printing, he/she opens a window relating to the printing settings, and sets the printer settings and the printing processing method for the printer driver including selection of the printing mode.

The multifunction peripheral 206 includes a printer CPU (CPU) 12, which loads into a RAM 19 a control program stored in a program ROM of a ROM 13 or in an external memory 14, and executes the control program on the RAM 19. The CPU 12 outputs an image signal as output information to a print unit (printer engine) 17 connected to a system bus 15 based on the loaded program and the like.

Further, in the program ROM of the ROM 13, a control program of the CPU 12 is stored. In a font ROM of the ROM 13, font data to be used when generating the output information is stored. In a data ROM of the ROM 13, when the printer does not have an external memory 14 such as a hard disk, information to be utilized on the client computer is stored.

The CPU 12 is configured so that it can communicate with the computer 201 via an input/output unit 18, and notify the computer 201 about information and the like in the multifunction peripheral 206.

The multifunction peripheral 206 also includes a RAM 19, which functions as a main memory and work area for the CPU 12. The RAM 19 is configured so that its memory capacity can be expanded by an optional RAM connected to a not-illustrated expansion port. The RAM 19 is used in an output information rasterization region, an environment data storage region, a non-volatile RAM (NVRAM), the storage device and the like. Access to the external memory 14, such as a hard disk (HD), integrated circuit card (IC card) and the like, is controlled by a memory controller 20. The storage device is a storage unit for storing the below-described device configuration data. In the present exemplary embodiment, the storage device is configured so as to be recognized from the computer 201 as its own external memory.

The external memory 14 is connected as an option, and may store font data, an emulation program, form data, and the like. An operation unit 22 is provided with switches, LED display devices and the like for operating the multifunction peripheral 206, and also has a touch panel, which has a large liquid crystal display apparatus.

Further, the number of external memories 14 is not limited to one. At least one or more external memories 14 may be used. Furthermore, a configuration may also be used in which, in addition to built-in fonts, an optional font card and a plurality of external memories 14 storing a program for interpreting printer control languages from different language systems are connected.

Still further, the external memory 14 may copy and store data which is stored on the RAM 19 in the printer body. The external memory 14 may also have a not-illustrated NVRAM, and store printer mode setting information from the operation unit 22.

A reading unit 24 transfers read data to the RAM 19 via a scanner interface 23 and the system bus 15.

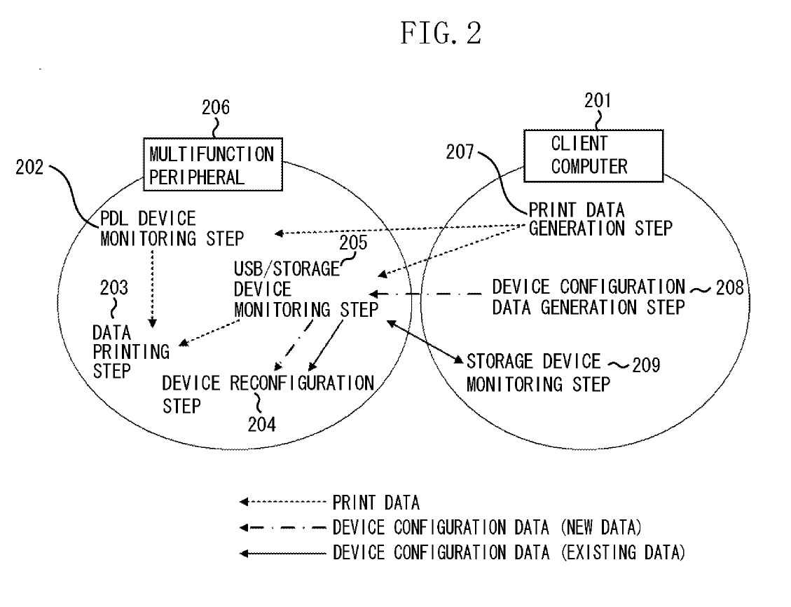

FIG. 2 is a schematic diagram illustrating data processing steps in the printing system illustrated in FIG. 1. This example illustrates an example of a printing system in which the multifunction peripheral 206 and the computer 201 are capable of communicating via a USB interface.

In FIG. 2, the multifunction peripheral 206 includes the reading unit 24, which functions as a scanner, and a PDL processing device, which generates print data by analyzing different kinds of PDL data. The PDL processing device is stored as a module. The processing of the PDL data is realized by the CPU 12 executing the PDL processing device.

In the present exemplary embodiment, the term “PDL” refers to a print data language that can be interpreted by the printer. Examples of widely known PDLs include PCL from Hewlett-Packard, and PostScript from Adobe. In the following description, “print data language” will be abbreviated as “PDL”.

The multifunction peripheral 206 is configured from a PDL device monitoring step 202, a data printing step 203, a device reconfiguration step 204, and a USB/storage device monitoring step 205.

In the PDL device monitoring step 202, monitoring of the print data sent to the multifunction peripheral 206 from the computer 201 via the USB interface is performed. When it is determined in the PDL device monitoring step 202 that print data has been sent from the computer 201, the print data is sent to the data printing step 203.

In the data printing step 203, the print data sent to the multifunction peripheral 206 from the computer 201 via the USB interface is interpreted, and printing is performed by the print unit 17.

If a plurality of PDL processing devices which generate print data by analyzing a plurality of pieces of PDL data are mounted on the multifunction peripheral 206, printing is carried out by performing raster conversion processing by the optimum PDL processing device based on the format (PDL) of the print information sent from the computer 201. In the present exemplary embodiment, the PDL processing device is configured so that the print information can be processed based on a plurality of page description languages. These page description languages include PCL5e, PCL6, and the like. Based on the device configuration data stored in the storage unit from the computer 201, the plurality of PDL processing devices execute device configuration processing so that any of the PDL processing devices becomes active. As a result, only the PDL processing devices corresponding to the device drivers selected by the user on the computer 201 become active.

In the device reconfiguration step 204, reconfiguration of the composite USB devices of the multifunction peripheral 206 is performed based on the below-described device configuration data. Specifically, device information about the PDL processing devices which will be in an active state is generated. These PDL processing devices correspond to the devices designated by the device configuration data sent from the computer 201 and stored in the storage unit. Transfer information may be generated and sent to the PC side based on the device configuration data stored in the USB storage of the multifunction peripheral, or the same data as the device configuration data may be used as the transfer information.

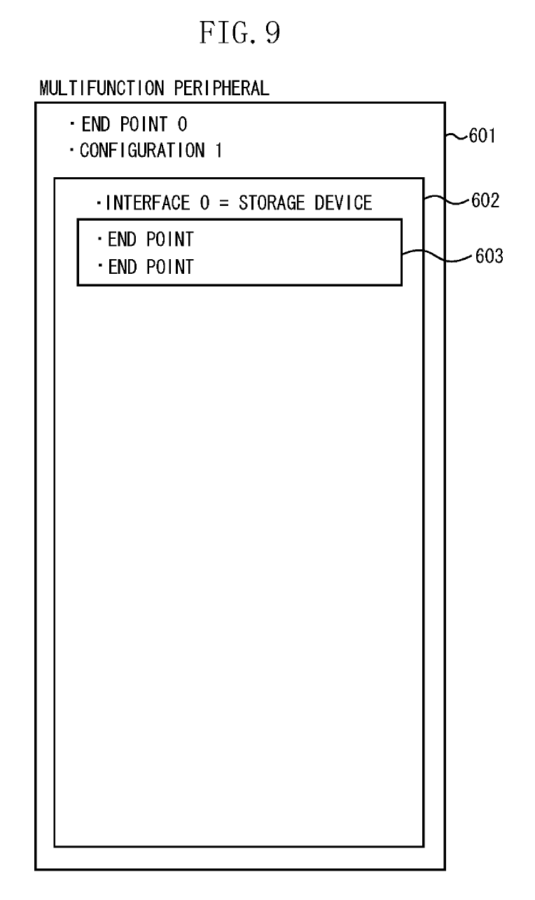

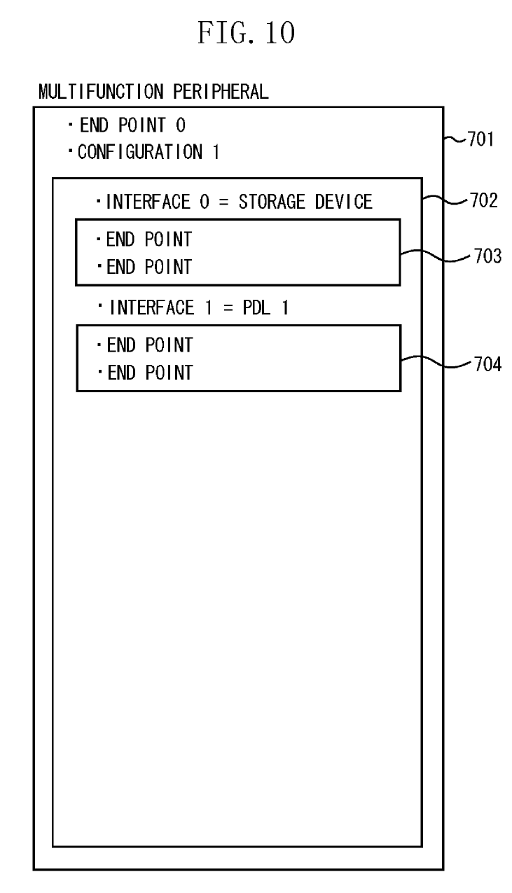

An example of the device configuration based on the generated device information is illustrated in FIGS. 9 and 10. This example illustrates an example of the composite USB device configuration managed on the storage unit of the multifunction peripheral 206. This composite USB device configuration is generated as follows when it is recognized that the USB cable is connected to the multifunction peripheral 206. Specifically, in the USB/storage device monitoring step 205, the addition of device configuration information into the storage unit is detected. Based on that detection, in the device reconfiguration step 204, the device configuration is changed, and then the composite USB device configuration is generated.

In the USB/storage device monitoring step 205, the USB cable connection state between the multifunction peripheral 206 and the computer 201 is monitored, and the storage device which is on the multifunction peripheral 206 is monitored.

Further, in the USB/storage device monitoring step 205 monitoring the USB/storage device, monitoring is performed as to whether the USB cable is in a connected state capable of communication with the input/output unit 18, or in an unconnected state not capable of communication. In the USB/storage device monitoring step 205, monitoring is also performed as to whether the USB cable is in a connected state with the input/output unit 18 by transitioning to a communication state from a non-communication state, or in an unconnected state with the input/output unit 18 by transitioning to a non-communication state from a communication state.

Furthermore, the USB/storage device monitoring step 205 moves control to the device reconfiguration step 204 when the USB cable connection is released, or when device configuration data has been added into the storage device.

Moreover, when print data generated by the PDL has been added into the storage device, the USB/storage device monitoring step 205 sends the print data to the data printing step 203.

In FIG. 2, the client computer (computer) 201 is configured from a print data generation step 207, a device configuration data generation step 208, and a storage device monitoring step 209.

In the print data generation step 207, print data generated by an application software program operating on the computer 201 is converted into PDL data by various PDL drivers, and the converted PDL data is sent to the multifunction peripheral 206. In typical print processing, the PDL data generated by the print data generation step 207 is sent to the PDL device monitoring step 202 of the multifunction peripheral 206, where the PDL data is processed. Then, the processed PDL data is passed onto the data printing step 203, and printed.

However, this processing may also be carried out by generating data which has once been converted into a PDL by a PDL driver, storing this data in the external memory 11 of the computer 201, and then sending the data from the computer 201 to the storage device of the multifunction peripheral 206. In this case, in the USB/storage device monitoring step 205, print data generated by analysis of print information generated based on any of the PDLs is sent to the data printing step 203. In the device configuration data generation step 208, the scanner or PDL device which the user wishes to use is selected based on an instruction from the user made on the computer 201, that result is generated in the form of device configuration data, and the generated device configuration data is sent to the multifunction peripheral 206. The device configuration data generated in the device configuration data generation step 208 is sent to the storage device of the multifunction peripheral 206. The USB/storage device monitoring step 205 of the multifunction peripheral 206 detects this, and the processing proceeds to the device reconfiguration step 204 on the device side. As a result, the composite USB device configuration of the multifunction peripheral 206 is changed.

In the storage device monitoring step 209, monitoring is performed as to whether the storage device present in the multifunction peripheral 206 has disappeared from view from the computer 201. In the storage device monitoring step 209, it is determined whether the USB cable connection has been disconnected or not by monitoring of the presence of the storage device. When the presence of the storage device is temporarily lost and then again restored, in the storage device monitoring step 209, the device configuration data is again added into the storage device.

As a result, the device configuration data is detected in the USB/storage device monitoring step 205, and control on the device side is moved to the device reconfiguration step 204.

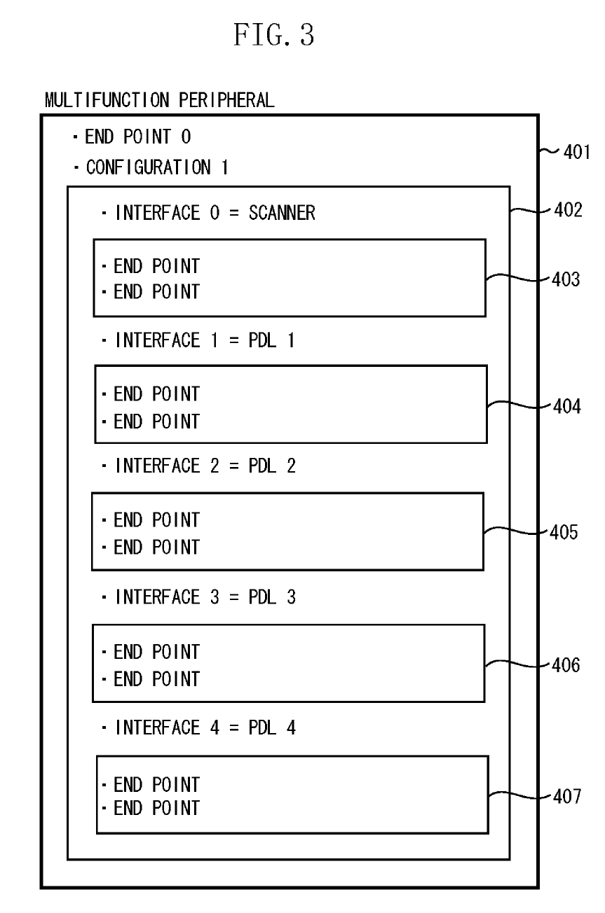

FIG. 3 illustrates an ordinary interface configuration of the multifunction peripheral 206 illustrated in FIG. 1. In this example, for the purpose of comparison with the present invention, a configuration of an ordinary composite USB that does not employ the present invention is illustrated.

The example illustrated in FIG. 3 includes a composite USB 401 of the whole multifunction peripheral 206. A configuration 402 is present in the composite USB 401, and a plurality of interfaces 403, 404, 405, 406, and 407 is present in the configuration 402. In this example, each of the interfaces 403, 404, 405, 406, and 407 is an individual element configuring the multifunction device.

The interface 403 corresponds to a scanner device. The interface 404 corresponds to a PDL 1 device. The interface 405 corresponds to a PDL 2 device. The interface 406 corresponds to a PDL 3 device. The interface 407 corresponds to a PDL 4 device.

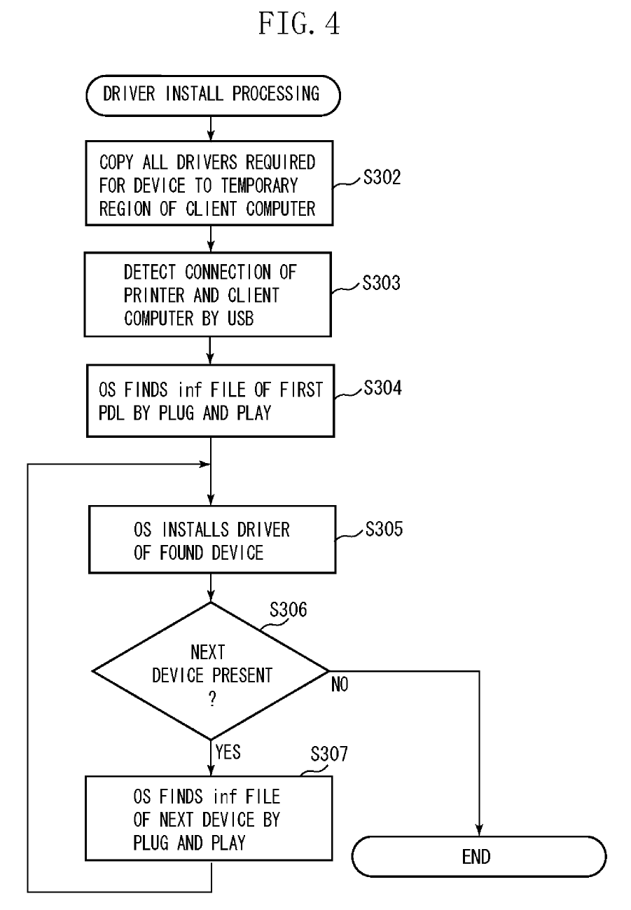

FIG. 4 is a flowchart illustrating data processing in the information processing apparatus according to an exemplary embodiment of the present invention. This example is an example of conventional driver installation processing for an ordinary composite USB device by the computer 201. Here, “an example of conventional driver installation processing” means an example of ordinary driver installation processing which does not employ the present invention. Each of the steps is realized by the CPU 1 loading and executing a driver installation program stored in the external memory 11 or ROM 3 on the RAM 2.

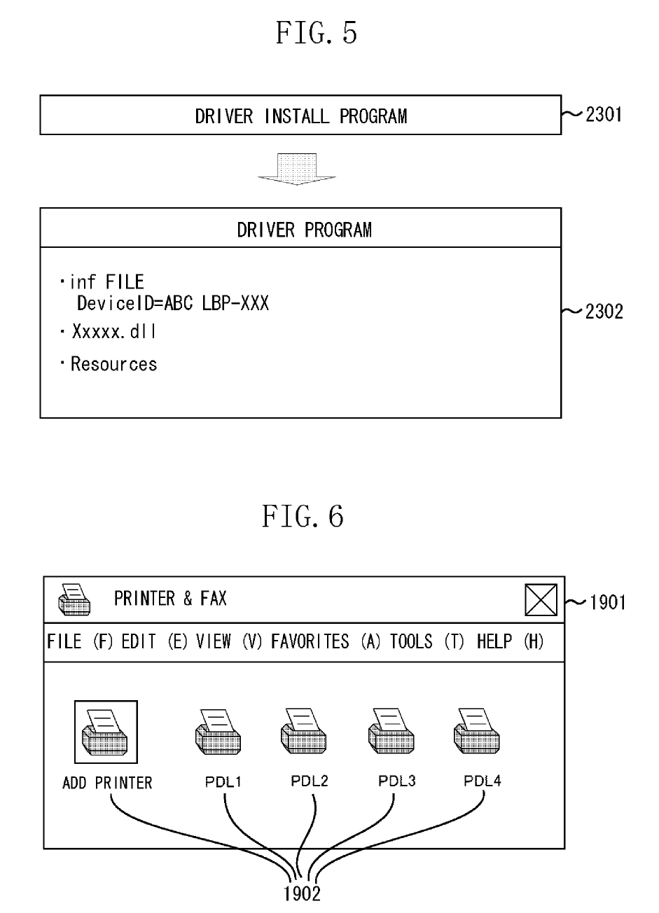

FIG. 5 illustrates a configuration of a driver installation module from an image forming apparatus according to an exemplary embodiment of the present invention.

The example illustrated in FIG. 5 includes a driver installation program 2301, which is stored in the external memory 11, such as a CD, HDD, memory device, and the like. Usually, for one installation program, an operation is performed in which one or a plurality of driver programs is installed. The example illustrated in FIG. 5 further includes a driver program 2302, which may also be called a driver set. The driver program is configured by an inf file, which describes unique information which is referenced during installation, various execution modules (various dynamic link libraries (dll)), and resources.

If the driver installation program 2301 is started and the processing starts with conventional driver installation processing, the processing proceeds to step S302. In step S302, the driver installation program 2301 copies the driver program 2302, which is stored in the external memory 11, such as a CD, HDD, or memory device, to a temporary region of the external memory 11, such as a HDD. This prepares the processing so that the driver program 2302 can be referenced by plug and play.

Next, in step S303, if the CPU 1 detects via the printer I/F 8 that the user has connected the USB cable of the multifunction peripheral 206 to the computer 201, the OS detects that plug and play has occurred.

Then, in step S304, as a result of the OS of the computer 201 detecting that plug and play has occurred, the OS finds the inf file of the device (scanner or PDL) that has been notified first from the temporary region of the HDD.

Then, in step S305, the OS of the computer 201 installs the driver program into the OS based on the detected inf file, and the OS registers the driver program as the device driver.

Next, in step S306, with completion of the installation of the first device driver, the OS of the computer 201 confirms whether a next device is present. If the device is a multifunction peripheral, usually, once the installation of one device driver is completed, the next device successively appears.

Then, if the OS confirms that the next device is defined (YES in step S306), the processing proceeds to step S307. If the OS confirms that the next device is not defined (NO in step S306), the present processing ends.

In step S307, if the OS finds the inf file of the next device (scanner or PDL) from the temporary region of the HDD, the processing returns to step S305.

From the above processing, the processing for installing the device drivers for all of the logic devices mounted on the multifunction peripheral 206 is completed.

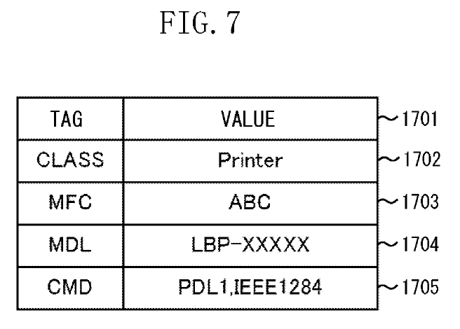

In the example illustrated in FIG. 3, one scanner and four PDLs are defined for the multifunction peripheral 206. As a result, four printer icons 1902 corresponding to the four PDLs are generated as in the user interface 1901 illustrated in FIG. 6. Each of the printer icons 1902 corresponds to the respective PDL illustrated in FIG. 3. Further, one scanner driver is registered. An icon corresponding to the scanner driver is not illustrated in FIG. 6. The plug and play scheme illustrated in the present exemplary embodiment will be described using FIG. 7.

FIG. 7 illustrates a plug and play scheme in a typical computer system.

In FIG. 7, device information 1701 defined in IEEE 1284 is configured by a class 1702, an MFC (manufacturer name) 1703, an MDL (product model) 1704, and a CMD (command) 1705.

The driver program (2302 in FIG. 5) stored in a temporary region of the external memory 11, such as a HDD, illustrated in FIG. 1 is configured from an inf file describing unique information which is referenced during driver installation, various execution modules, and resources.

A device ID which is referenced during plug and play is described in the inf file of the printer driver. In this device ID, a value is described which matches a value configured by combining the MFC 1703 and MDL 1704 of FIG. 7. A value which matches the vendor ID (manufacturer ID), the product ID, and an interface number defined in the program ROM of the ROM 13 of FIG. 1 is described in the inf file of the scanner driver as the USB configuration.

If it is detected in step S303 illustrated in FIG. 4 that the USB cable of the multifunction peripheral 206 is connected to the computer 201, information about the various interfaces in FIG. 3 is successively sent from the multifunction peripheral 206 to the computer 201. Information about the various interfaces is referenced by the plug and play function executed by the OS, and the device drivers of the required devices are installed.

If the interface is the scanner, the vendor ID, the product ID, and the interface number are acquired from the multifunction peripheral 206. The information file in which information matching the vendor ID, the product ID, and the interface number is described is searched for from among the inf files stored in the temporary region of the external memory 11, such as an HDD. The vendor ID (manufacturer ID) and the product ID are provided for a product unit, and thus these are common values among all of the interfaces 403 to 407.

Further, if the information about the interface notified from the multifunction peripheral 206 is that the interface is a printer, the OS of the computer 201 performs the following processing. First, the OS of the computer 201 acquires the device ID compliant with IEEE 1284 from the multifunction peripheral 206. Then, the OS of the computer 201 searches for the inf file in which information matching the acquired device ID is described from among the inf files stored in the temporary region of the same HDD, which corresponds to the external memory 11.

Thus, the OS of the computer 201 can perform installation by executing plug and play and correctly associating with the driver corresponding to the device. In the present exemplary embodiment, the computer 201 is notified of the device information generated based on the device configuration data stored in the storage unit.

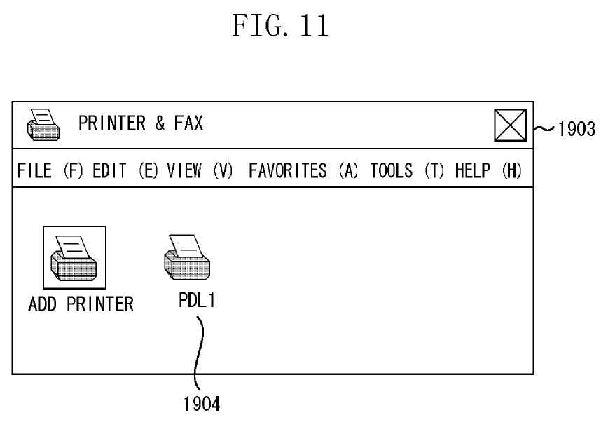

As a result, if the OS of the computer 201 executes the above-described plug and play, installation is restricted to the device driver corresponding to the device driver pre-selected by the user via the user interface illustrated in FIG. 11. After installation, only the printer icon corresponding to the installed device driver is displayed.

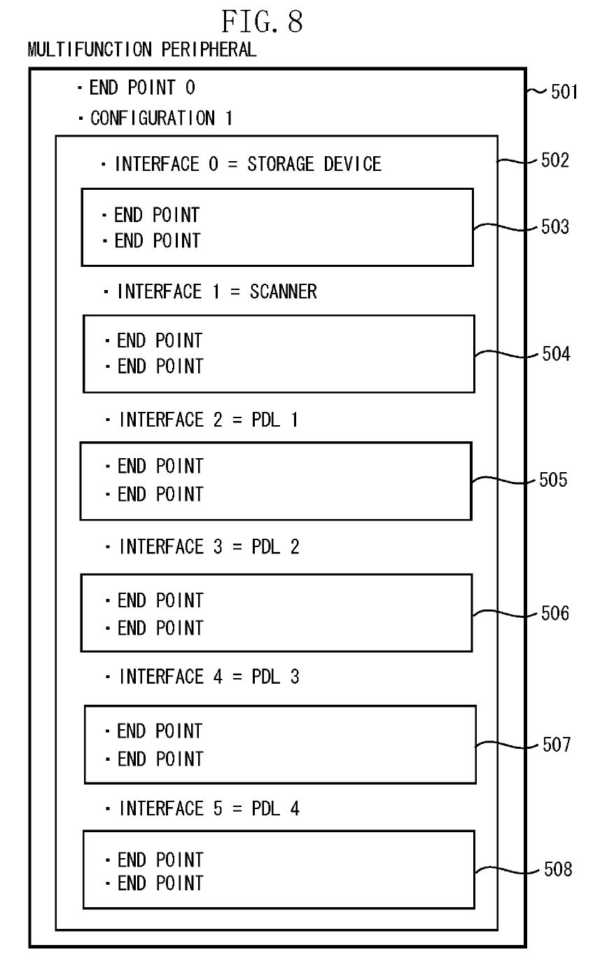

FIGS. 8 to 10 illustrate interface configurations of the multifunction peripheral 206 illustrated in FIG. 1. This example illustrates the composite USB configuration corresponding to the present invention. Further, this example illustrates an example of a maximum configuration (case where all of the devices present in the multifunction peripheral 206 are active).

The differences with the configuration of the interface illustrated in FIG. 3 will now be described.

The significant difference between the interface illustrated in FIG. 3 and the interfaces illustrated in FIGS. 8 to 10 is that in FIG. 8, the storage device is defined as the interface 0. Information about the interface 0 is illustrated as an interface 503.

The example illustrated in FIG. 8 includes a composite USB device 501 of the whole multifunction peripheral 206. One configuration 502 is present in the composite USB device 401, and a plurality of interfaces 503, 504, 505, 506, 507, and 508 is present in the configuration 402. Each of these interfaces is an individual element configuring the multifunction device.

The interface 503 in FIG. 8 corresponds to the storage device. The interface 504 corresponds to a scanner device. The interface 505 corresponds to a PDL 1 device. The interface 506 corresponds to a PDL 2 device. The interface 507 corresponds to a PDL 3 device. The interface 508 corresponds to a PDL 4 device.

FIG. 9 illustrates a composite USB device configuration of during product shipment or when the USB cable corresponding to a two-way interface 21 between the multifunction peripheral 206 and the computer 201 has been unplugged to release the connection.

The characteristic of FIG. 9 is that the multifunction peripheral 206 has only the storage device of the interface 603, which corresponds to the interface 0.

The example illustrated in FIG. 9 is includes a composite USB device 601 of the whole multifunction peripheral 206, one configuration 602 which is present in the composite USB device 601, and one interface 603 which is present in the configuration 602, which are individual elements configuring the multifunction device.

FIG. 10 also illustrates a composite USB device configuration according to an exemplary embodiment of the present invention.

The example illustrated in FIG. 10 includes a composite USB device 701 of the whole multifunction peripheral 206, one configuration 702 which is present in the composite USB device 701, and a plurality of interfaces 703 and 704 which are present in the configuration 702. Each of these interfaces is an individual element configuring the multifunction device.

The interface 703 illustrated in FIG. 10 corresponds to the storage device, and the interface 704 corresponds to the PDL 1. Thus, in this example, as illustrated byauser interface 1903 illustrated in FIG. 11, a printer icon 1904 corresponding to one PDL is generated. Since the printer icon 1904 is displayed so that only it can be selected, the user can confirm the device to be used to process the page description language. In the present exemplary embodiment, as described below, only the printer icon corresponding to the page description language processing unit (PDL processing device) selected by the user is displayed.

FIG. 11 illustrates an example of a user interface which can be displayed by the computer 201 illustrated in FIG. 1.

In FIG. 11, the printer icon 1904 corresponds to the PDL 1 as the device. This interface combination is just one example. As long as the configuration always includes the storage device and then combines the respective interfaces described in FIG. 5, any combination may be used without a problem.

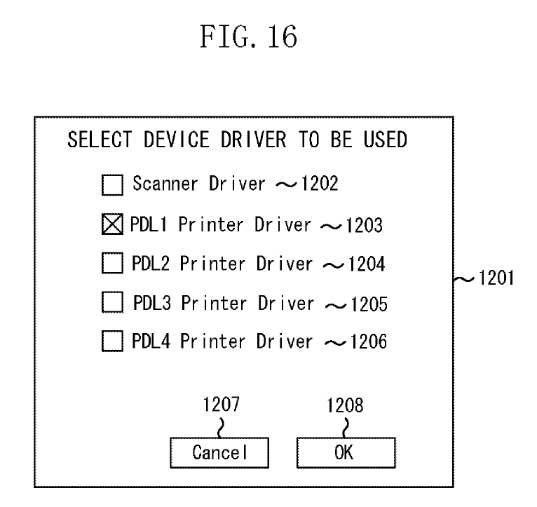

The number of icons in FIG. 11 and the number of devices selected by the user at the user interface illustrated in FIG. 16 by the computer 201 are displayed so as to match. Namely, after the device configuration data based on the devices selected by the user is stored in the storage unit, there is no display of icons corresponding to devices other than those selected by the user.

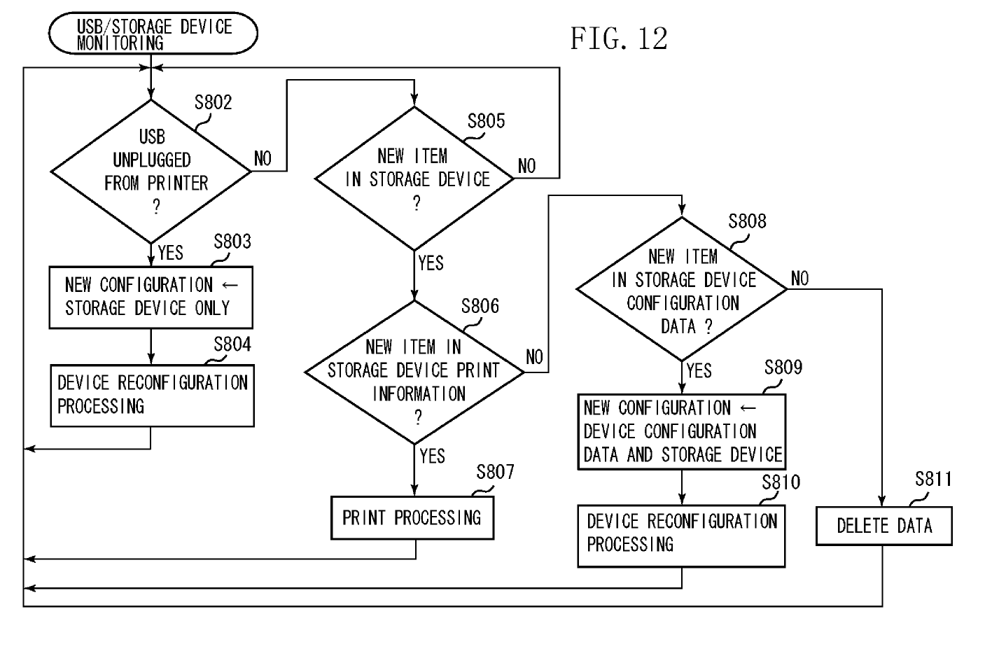

FIG. 12 is a flowchart illustrating an example of data processing in the image forming apparatus according to an exemplary embodiment of the present invention. This example is a processing example of monitoring the connection state of the USB cable (corresponding to the two-way interface 21 illustrated in FIG. 1) for two-way connection of the multifunction peripheral 206 and the computer 201, and monitoring the state of the storage device assigned as the RAM 19. Each step is realized by the CPU 12 loading into the RAM 19 a program stored in the ROM 13 present in the multifunction peripheral 206 illustrated in FIG. 1 or in the external memory 14, and executing the loaded program.

Here, “storage device” refers to a storage device managed by each of the interface 503 illustrated in FIG. 8, the interface 603 illustrated in FIG. 9, and the interface 703 illustrated in FIG. 10. Specifically, the storage device is configured utilizing a part of the RAM 19 included on the multifunction peripheral 206 illustrated in FIG. 1.

This storage device can be viewed as a type of external memory 11 which utilizes a function of the OS (not illustrated) from the computer 201 illustrated in FIG. 1.

Namely, when the storage device on the computer 201 is referenced, it is actually the RAM 19 of the multifunction peripheral 206 which is being referenced.

Each step in FIG. 12 is realized by the CPU 12 loading and executing a program stored in the external memory 14 or ROM 13 on the RAM 19.

If the USB/storage device monitoring processing is started, then in step S802, the CPU 12 determines whether the USB cable (the two-way interface 21 illustrated in FIG. 1) connected to the input/output unit 18 has been unplugged from the multifunction peripheral 206.

If the CPU 12 determines that a connected USB cable has been unplugged (YES in step S802), the processing proceeds to step S803. If the CPU 12 determines that there is no change in the connection state of the USB cable (NO in step S802), the processing proceeds to step S805. The expression “no change in the connection state of the USB cable” refers to a case where, for example, an unplugged USB cable remains unplugged, or where a connected USB cable remains connected.

In step S803, since the connected USB cable has been unplugged, the new device configuration should only be the storage device, and thus the new configuration is set as storage device only.

Then, in step S804, the processing moves control to the device reconfiguration processing for updating the device configuration. Once the device reconfiguration processing ends, the processing returns to step S802, and the CPU 12 again monitors whether there is any change in the state of the USB cable connected to the input/output unit 18.

As described above, in step S802, if the CPU 12 determines that there is no change in the connection state of the USB cable because it is already unplugged, the CPU 12 does not determine that the USB cable is in an unplugged state. Namely, the CPU 12 determines that the USB cable has been unplugged only if the USB cable has been connected when the determination in step S802 has been made and then has been subsequently unplugged.

In step S805, the CPU 12 determines whether a new item has been stored in the storage device. Here too, the CPU 12 monitors state changes in the same manner as in step S802. In step S805, if the CPU 12 determines that there is no change in the state (case where the stored items remain as is), the CPU 12 does not determine that a new item has been stored. Namely, when a new item is newly added, or when an already-stored item is deleted and then stored again, the CPU 12 determines that a new item has been stored.

If the CPU 12 determines that a new item has been stored in the storage device (YES in step S805), the processing proceeds to step S806. If the CPU 12 determines that a new item has not been stored in the storage device (NO in step S805), the processing returns to step S802. The processing may optionally be controlled so that a suitable time gap is inserted before returning to step S802 so as not to waste the capabilities of the CPU 12 of FIG. 1.

In step S806, the CPU 12 determines whether the new data stored in the storage device is print data. In the multifunction peripheral 206 illustrated in the present exemplary embodiment, the storage device can be viewed as a type of external memory 11 of the computer 201, which utilizes a function of the OS (not illustrated) from the computer 201.

The user of the computer 201 can send the print information of the installed PDL driver to the multifunction peripheral 206 for direct printing, or can output an output result of the PDL driver to the external memory 11. In this case, the output result of the PDL driver stored on the external memory 11 is moved to the storage device which can be viewed as a part of the external memory 11. Thus, that information is sent to the multifunction peripheral 206 via the USB cable corresponding to the two-way interface 21, and then stored on the storage device of the RAM 19.

In step S806, the CPU 12 determines whether the information stored on the storage device is print information corresponding to the output result of the PDL driver. If the CPU 12 determines that this information is print information corresponding to the output result of the PDL driver (YES in step S806), the processing proceeds to step S807. In step S807, print data generated by analyzing the print information in the same manner as in typical print processing is printed. The processing then returns to step S802.

The storage device of the multifunction peripheral 206 can be handled as a single folder by a function of the OS (not illustrated). A folder that enables printing only by dropping a job in the folder is generally called a “hot folder”. Therefore, a hot folder function is also realized in the present exemplary embodiment. Further, the print data is deleted from the storage device after it is printed.

On the other hand, in step S806, if the CPU 12 determines that the data newly stored into the storage device is not an output result of the PDL driver (NO in step S806), the processing proceeds to step S808.

In step S808, the CPU 12 of the multifunction peripheral 206 determines whether the data newly stored into the storage device is device configuration data.

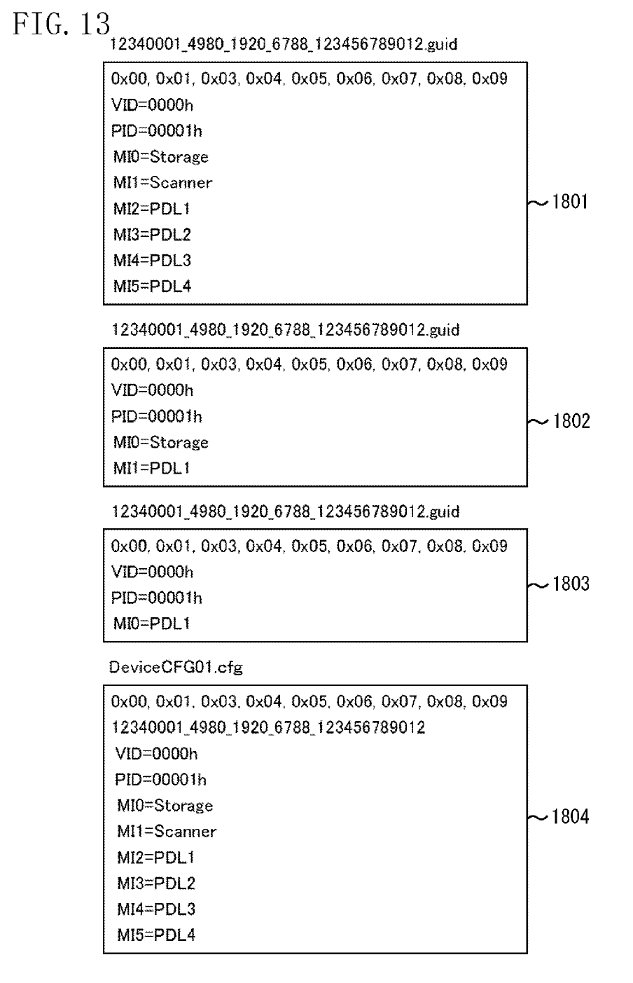

FIG. 13 illustrates an example of device configuration data stored in the multifunction peripheral 206 illustrated in FIG. 1.

The example illustrated in FIG. 13 includes device configuration data 1801 to 1804. Device configuration data 1801 to 1804 utilize a globally unique identifier (GUID) of the OS which is running on the computer 201 as their data file name, and have “.guid” as an extension. The GUID is a predetermined pseudorandom number configured from a 128-bit binary number. It is generally said that no two numbers have the same value. The GUID is a number that helps in uniquely identifying individual OSs. In the present exemplary embodiment also, the GUID is used as information for uniquely identifying the OS which is running on the computer 201 by using a binary number generated by a predetermined pseudorandom number. In the present exemplary embodiment, the device configuration data can be managed by uniquely identifying the OS of the client computer which is the transfer source using this GUID.

In FIG. 13, device configurationdata 1801, 1802, 1803, and 1804 include a tag 0x01, 0x01, 0x02, 0x04, 0x05, 0x06, 0x07, 0x08, 0x09 in their top line. This tag 0x01, 0x01, 0x02, 0x04, 0x05, 0x06, 0x07, 0x08, 0x09 indicates that the data is device configuration data. The tag can be used to determine that the data is device configuration data by examining several bytes in the top line of the file.

Even if the file name is GUID.guid, such as for device configuration data 1801, 1802, and 1803, the CPU 12 of the multifunction peripheral 206 can ultimately determine that such data is device configuration data by checking several bytes in the top line of the file. This is the same even in cases where the file name is DeviceCFG01.cfg, such as for device configuration data 1804. The value and the length are not limited to those described above, and may be arbitrary values and length as long as they are thought to be capable of uniquely identifying the file contents.

Device configuration data 1801 indicates that the device with the vendor ID (manufacturer ID) 0000h, product ID 00001h, and interface number 0 is the storage device.

Further, device configuration data 1801 indicates that the device with the interface number 1 is the scanner, the device with the interface number 2 is the PDL 1, the device with the interface number 3 is the PDL 2, and the device with the interface number 4 is the PDL 4.

Device configuration data 1802 indicates that the device with the vendor ID (manufacturer ID) 0000h, product ID 00001h, and interface number 0 is the storage device. Device configuration data 1802 also indicates that that the device with the interface number 1 is the PDL 1. As a result of reconfiguring the device based on the device configuration data 1802, the devices illustrated in FIG. 10 are configured.

The device configuration data illustrated in FIG. 13 is just one example. The present invention is in no way limited to this format.

In step S808 illustrated in FIG. 12, if the CPU 12 of the multifunction peripheral 206 determines that the data newly stored in the storage device is device configuration data (YES in step S808), the processing proceeds to step S809. If the CPU 12 determines in step S808 that the data newly stored in the storage device is not device configuration data (NO in step S808), the processing proceeds to step S811.

In step S809, in addition to the storage device, the new device configuration (in FIG. 12, this is written as “new configuration”) should also be the selected device configuration data. Thus, the new configuration is set as the storage device and the selected device configuration data.

Next, in step S810, the processing moves control to the device reconfiguration processing for updating the device configuration, and then the processing returns to step S802. At this stage, the device configuration data is not deleted even after the device reconfiguration, and remains in the storage device.

When the processing returns to step S802, the CPU 12 again monitors whether there is any change in the state of the USB cable. As described above, in step S802, if the USB cable has already been unplugged and in a non-connected state, so that there has been no change in its state, the CPU 12 does not determine that the USB cable has been unplugged.

The CPU 12 determines that the USB cable has been unplugged and in a non-connected state only if the USB cable has been connected when the determination in step S802 has been made, and then has been subsequently unplugged.

On the other hand, in step S808, if the CPU 12 determines that the data newly stored in the storage device is not device configuration data (NO in step S808), it is clear that that the newly stored data is neither device configuration data, nor is it print data output by the PDL driver. Since the data which is received by the storage device of the RAM 19 of the multifunction peripheral 206 is either device configuration data or print data output by the PDL driver, in this case the data stored in the storage device is data that cannot be processed.

Therefore, in step S811, the CPU 12 simply deletes the data stored in the storage device on the RAM 19, the processing returns to step S802, and the CPU 12 again monitors whether there is any change in the USB cable state.

There is no end in the flowchart illustrated in FIG. 12. The reason why there is no end in this flow is that from the point when the multifunction peripheral 206 is started, the flow illustrated in FIG. 12 is set in motion, so that as long as the device is operating, the processing continues without finishing.

As described above, in the processing illustrated in FIG. 12, when the connection state transitions to a disconnected state due to the USB cable becoming unplugged, the configuration can be changed to a storage device only device. Further, the configuration can also be changed to devices based on an instruction about the device configuration data added from the computer 201 to the storage device on the RAM 19.

Further, print data generated by analyzing print information output by the PDL driver added into the storage device can be printed. Still further, data other than the above-described data added into the storage device can be deleted and ignored.

As a result, the multifunction peripheral deletes the device configuration data from the storage unit when, after the device configuration data is stored in the storage unit, the USB cable, which has been initially connected to and capable of communication with the information processing apparatus, is unplugged from the information processing apparatus or the multifunction peripheral. The processing of the device configuration data in the storage unit for a case where a connected USB cable is unplugged and then reconnected, will be described below.

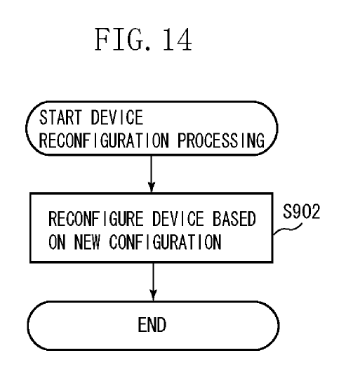

FIG. 14 is a flowchart illustrating an example of data processing in the image forming apparatus according to an exemplary embodiment of the present invention. This example is a detailed processing example of processing for reconfiguring the device configuration by changing the state of the logical devices present in the multifunction peripheral 206 in step S810 to active or non-active. Step S902 is realized by the CPU 12 executing a program stored in the program ROM 13 present in the multifunction peripheral 206 illustrated in FIG. 1 or in the external memory 14.

In step S902, the CPU 12 performs device reconfiguration based on the device configuration data corresponding to the new configuration acquired from the computer 201, and the present processing ends.

For example, if the device configuration data corresponding to the new configuration is storage device only, then in step S902, the CPU 12 changes the composite USB device configuration as illustrated in FIG. 9, and restarts the multifunction peripheral 206.

Further, if the device configuration data corresponding to the new configuration is configured by the storage device and the PDL 1, then in step S902, the CPU 12 changes the composite USB device configuration, and restarts the multifunction peripheral 206.

In the present exemplary embodiment, this processing is not executed only when the multifunction peripheral 206 restarts. The present invention also includes a method where, in the present exemplary embodiment, the USB is logically reconfigured by performing device reconfiguration based on the device configuration data corresponding to the new configuration.

Thus, device reconfiguration can be performed based on the device configuration data corresponding to the new configuration by the processing illustrated in FIG. 14.

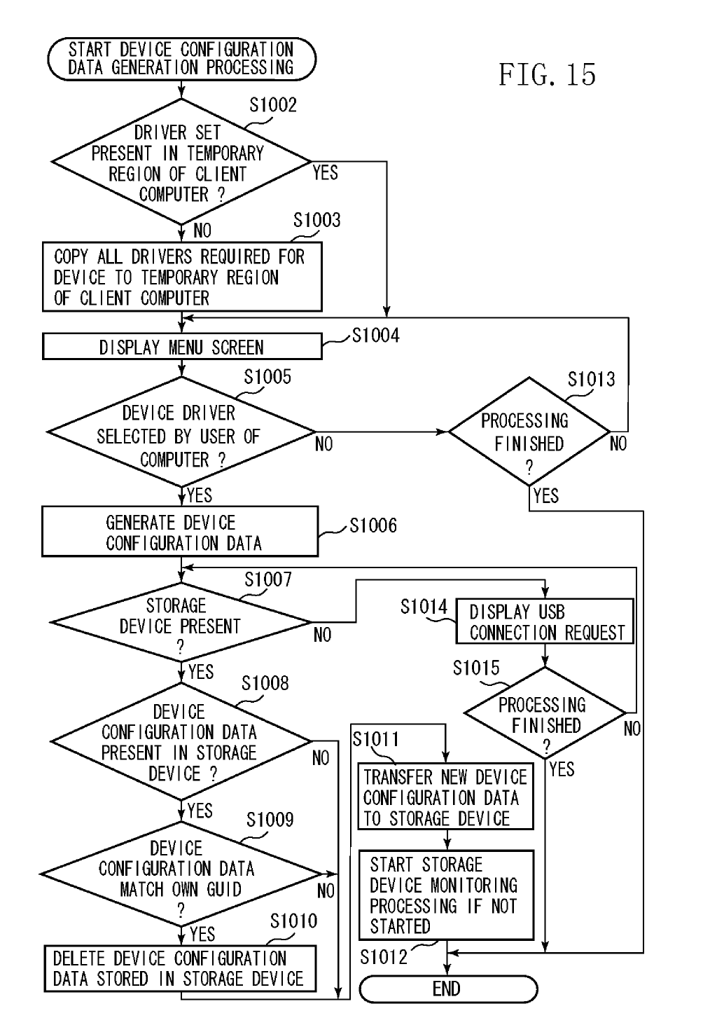

FIG. 15 is a flowchart illustrating an example of data processing in the information processing apparatus according to an exemplary embodiment of the present invention. This example is processing in which device configuration data is generated and stored in the storage device (RAM 19) of the multifunction peripheral 206 when the computer 201 installs the device driver. Each step is realized by the CPU 1 executing a program stored in the external memory 11 present in the computer 201.

The CPU 1 starts the driver installation program 2301 illustrated in FIG. 5, which is stored in the external memory 11 of the computer 201, such as a CD, HDD, or memory device.

In step S1002, the CPU 1 confirms whether a driver set is present in a temporary region of the external memory 11 of the computer 201. This temporary region of the external memory 11 is a region in which the presence of the inf file is confirmed from the OS (not illustrated) of the computer 201 during plug and play. If the CPU 1 determines that a driver set is present (YES in step S1002), the processing proceeds to step S1004. If the CPU 1 determines that a driver set is not present (NO in step S1002), the processing proceeds to step S1003.

Here, while step S1003 is skipped if a driver set is already present, step S1003 may be mandatorily executed without performing this determination. This type of processing is effective, for example, in order to use a new version of a driver when a different version of the driver is acquired.

In step S1003, the driver program stored in the external memory 11 of the computer 201, such as a CD, HDD, or memory device, is copied to a temporary region of the external memory 11. Performing this processing allows a search for the inf file to be carried out by the OS when the plug and play is subsequently performed.

In step S1004, the CPU 1 displays a menu screen on the display 10, such as the example illustrated in FIG. 16, for selecting the device driver to be used. The user of the computer 201 then selects the device driver which he/she wishes to use via that menu screen.

FIG. 16 illustrates an example of a user interface which is displayed on the display 10 illustrated in FIG. 1. This example is an example of a menu screen for selecting the device driver to be used.

The menu screen 1201 illustrated in FIG. 16 includes a check item 1202 which should be selected when using the scanner driver, and a check item 1203 which should be selected when using the PDL 1 driver.

The menu screen 1201 also includes a check item 1204 which should be selected when using the PDL 2 driver, a check item 1205 which should be selected when using the PDL 3 driver, and a check item 1206 which should be selected when using the PDL 4 driver.

The menu screen 1201 further includes a cancel button 1207 for advancing the processing forward without selecting a device driver, and an OK button 1208 for advancing the processing forward with the selected device driver. The menu screen illustrated in FIG. 16 is just an example, and the present exemplary embodiment is not limited to the selection items illustrated on this menu screen. By using the thus-configured menu screen 1201 to select the driver which he/she wishes to use, the user can instruct the device configuration data which should be set in the storage device to be generated.

Next, in step S1005, the CPU 1 determines whether a device driver has been selected by the user of the computer 201 on the menu screen illustrated in FIG. 16. Specifically, the CPU 1 determines that a device driver is selected if the OK button 1208 has been pressed and if a check box of one or more of the check items is checked from among the check items 1202 to 1206 illustrated in FIG. 16 (YES in step S1005), and the processing proceeds to step S1006.

On the other hand, if the CPU 1 determines that none of the check items 1202 to 1206 on the menu screen 1201 illustrated in FIG. 16 is checked, or that the cancel button 1207 on the menu screen 1201 illustrated in FIG. 16 is pressed (NO in step S1005), the processing proceeds to step S1013. This means that a device driver is not selected.

In step S1006, based on the check item which has been selected on the menu screen 1201 illustrated in FIG. 16, device configuration data 1801 and 1802 illustrated in FIG. 13 are generated. However, at this stage, information relating to the storage device is not set in the data.

Next, in step S1007, the CPU 1 of the computer 201 checks for the presence of the storage device. When viewed from the computer 201, the storage device (part of the RAM 19) of the multifunction peripheral 206 can be recognized as if it is an external memory 11.

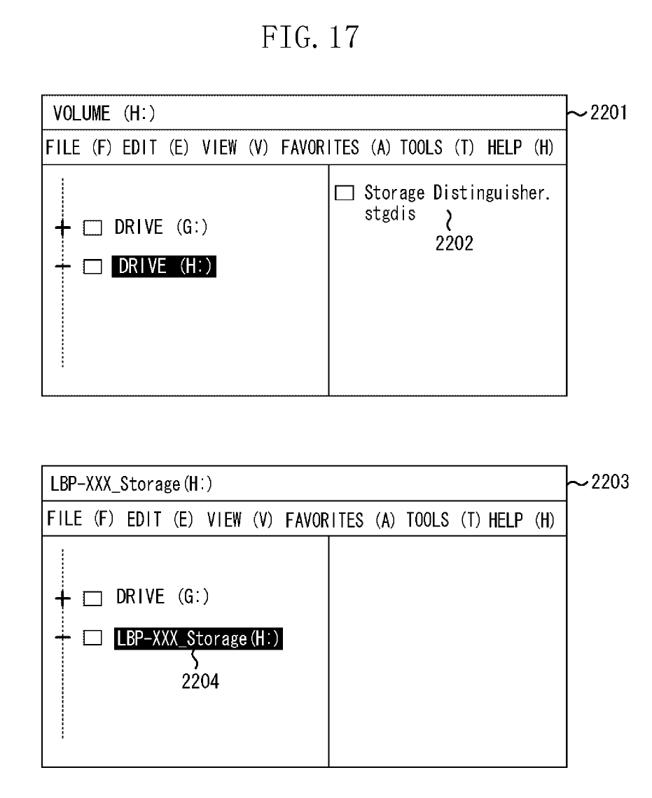

An example of a method for checking for the presence of the storage device is illustrated in FIG. 17. In this method, a non-display attribute storage device recognition tag file (in FIG. 17, the file with the file name 2202) is pre-stored in the storage device.

In addition, the CPU 1 successively checks the plurality of present external memories 11, and recognizes the device with this storage device recognition tag file as the storage device of the multifunction peripheral 206.

As another example of such method, a character string which is predetermined as a storage device volume name is embedded in the storage device, and the device having that character string as its volume name is recognized as the storage device of the multifunction peripheral 206. This example is illustrated in the volume name 2204 in FIG. 17.

FIG. 17 illustrates an example of a user interface which is displayed on the display 10 illustrated in FIG. 1. This example is an example of a confirmation screen of the storage device.

FIG. 17 illustrates an example of a volume screen 2201 for referencing the state of the external memory 11 on the computer 201 by utilizing a function of the OS (not illustrated).

The volume screen 2201 illustrates an example in which, as viewed from the computer 201, the storage device (part of the RAM 19) of the multifunction peripheral 206 appears as an H drive.

The example illustrated in FIG. 17 also includes a file 2202 which is present with a file name called StorageDistinguisher.stgdis in the H drive. This file name 2202 called StorageDistinguisher.stgdis is not limited to that name. By attaching to that file a name which would probably not be generated by other systems and leaving the contents of the file empty, whether a file with such file name is present or not can be confirmed. Additionally, the confirmation may be performed by carrying out both confirmation of the file name and of the contents by defining the contents of the file.

FIG. 17 also illustrates an example with a storage device volume screen 2203 and a storage device volume name 2204, which is defined as LBP-XXXX_Storage. In this case, if the device with the volume name 2204 called LBP-XXXX_Storage is present, the CPU 1 can determine that such device is the storage device (part of the RAM 19) of the multifunction peripheral 206.

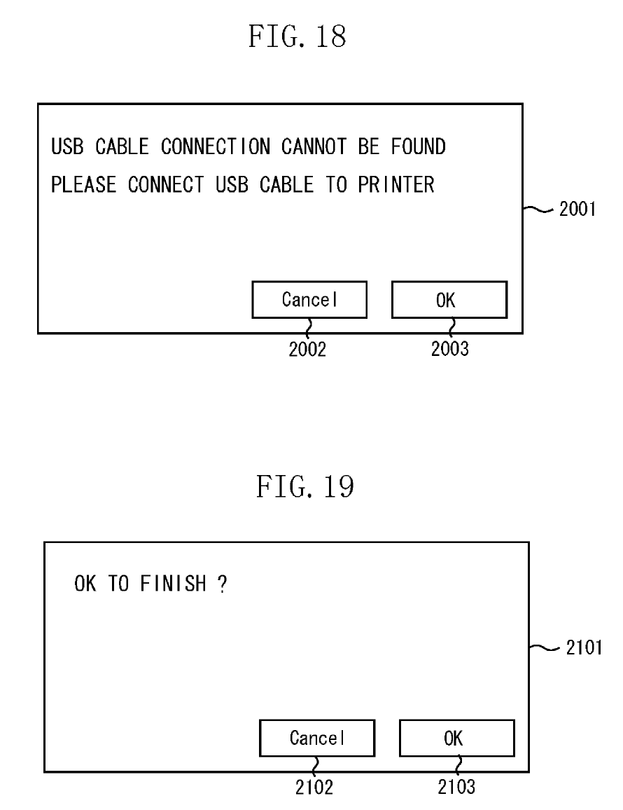

As a result of checking for the presence of the storage device, if the CPU 1 determines that the storage device is not present (NO in step S1007), there is a possibility that the computer 201 and the multifunction peripheral 206 are not connected by the USB cable (two-way interface 21 of FIG. 1). Therefore, the processing proceeds to step S1014, in which the user interface illustrated in FIG. 18 is displayed to prompt connection of the USB cable.

FIG. 18 illustrates an example of a user interface which is displayed on the display 10 illustrated in FIG. 1.

FIG. 18 illustrates an example of a screen 2001 for prompting the user to connect the USB cable to the multifunction peripheral 206.

If the user has no intention of connecting, he/she can press a cancel button 2002 on the screen 2001, whereby the processing proceeds to the next state. Further, if the USB cable has been connected, the user can press an OK button 2003, whereby the processing proceeds to the next state. This screen is just an example, and the present exemplary embodiment is not limited to this screen.

On the other hand, in step S1007, if the CPU 1 determines that the storage device is present (YES in step S1007), the processing proceeds to step S1008. In step S1008, the CPU 1 determines whether the device configuration data is present in the multifunction peripheral 206 storage device whose presence has been confirmed. If the CPU 1 determines that the device configuration data is present (YES in step S1008), the processing proceeds to step S1009. If the CPU 1 determines that the device configuration data is not present (NO in step S1008), the processing proceeds to step S1011.

In step S1009, the CPU 1 confirms whether the device configuration data stored in the storage device is generated as a file name which matches its own GUID. If the CPU 1 determines that the device configuration data matches the GUID (YES in step S1009), the processing proceeds to step S1010. If the CPU 1 determines that the device configuration data does not match the GUID (NO in step S1009), the processing proceeds to step S1011.

If the processing proceeds to step S1010, it is apparent that device configuration data matching its own GUID is present in the storage device of the multifunction peripheral 206. This must be the case because the computer 201 has performed this device configuration data generation processing, and the device configuration data with its own GUID is stored in the storage device of the multifunction peripheral 206. More specifically, this indicates that the generation processing of the device configuration data by the computer 201 has been executed at least not for the first time.

This situation can occur when the device configuration has been determined, but then the user has wanted to use a separate function after the operation had started, and thus has executed this device configuration data generation processing again.

In step S1010, the device configuration data with its own GUID already stored in the storage device of the multifunction peripheral 206 is deleted once. Thus, by deleting the device configuration data with its own GUID from the storage device of the multifunction peripheral 206, the USB/storage device confirmation processing of step S802 in FIG. 8 can be reset. As a result, by again adding the device configuration data with its own GUID into the storage device, whether a new item has been stored in the storage device can be detected in step S802 illustrated in FIG. 8. To delete the device configuration data stored in the storage device, information for specifying the device configuration data and a command instructing deletion are sent by the computer 201 to the multifunction peripheral 206. As a result, the CPU 12 of the multifunction peripheral 206 can delete the device configuration data from the RAM 19 constituting the storage device.

Next, in step S1011, the CPU 1 transfers the device configuration data generated based on the new configuration to the storage device of the multifunction peripheral 206 via the two-way interface 21. At this point, a non-display attribute and a read-only attribute are attached to the device configuration data using its own GUID as the file name, for example, the name GUID.guid, and the resultant device configuration data is stored in the multifunction peripheral 206. The device configuration data 1801 and 1802 illustrated in FIG. 13 are an example of such processing.

The reason for attaching the non-display attribute is that the contents of the storage device can be easily referenced, due to the fact that the storage device of the multifunction peripheral 206 can be viewed on the computer 201 as a part of the external memory 11. Further, the non-display attribute is also attached to prevent inadvertent correction by the user.

In addition, since the device configuration disappears if the device configuration data is mistakenly deleted, the read-only attribute is also attached to prevent inadvertent deletion.

In this example, the file in the multifunction peripheral 206 has a file name extension “.guid,” which allows the file to be identified as device configuration data. The GUID portion before the extension is used to identify the fact that such portion is data that has been generated by the client computer 201 itself.

Further, in the device configuration data illustrated in FIG. 13, 0x00, 0x01, 0x03, 0x04, 0x05, 0x06, 0x07, 0x08, 0x09 is described in the top line of the file. This indicates that the file configured from these several bytes is device configuration data. The value and the length are not limited to this example, and may be an arbitrary value and length as long as they are thought to be capable of uniquely identifying the file contents. Further, while the GUID has been used for the file name and .guid for the extension to identify the file as being device configuration data, the file extension is not limited to this.

Moreover, a configuration which does not use the GUID for the file name of the device configuration data may be employed, and the example illustrated by device configuration data 1804 in FIG. 13 may also be employed. In this device configuration data 1804, DeviceCFG01.cfg is used for the file name. This DeviceCFG portion is an example, and the present exemplary embodiment is not limited thereto.

Further, the subsequent 01 is a series number which is successively counted up from 01 in order of transfer to the storage device of the multifunction peripheral 206. This portion is also not limited to a two-digit number. Other contents may also be used, as long as the file can be uniquely identified.

In the top line of the file, 0x00, 0x01, 0x03, 0x04, 0x05, 0x06, 0x07, 0x08, 0x09 is described. With these several bytes, it is indicated that the file is device configuration data. The value and the length are not limited to this example, and may be an arbitrary value and length as long as they are thought to be capable of uniquely identifying the file contents.

In the second line of the file, the GUID value 12340001-4980-1920-6788-123456789012 is described.

If device configuration data has been generated in the format of the example illustrated by the device configuration data 1804, the following confirmation processing is executed in steps S1008 and S1009. In this confirmation operation, the processing is advanced while a plurality of pieces of device configuration data stored in the storage device of the multifunction peripheral 206 is successively read and the contents of the described GUID are successively confirmed.

Further, for the same reasons as described above, in this example too, a device configuration file may be stored with a non-display attribute and a read-only attribute attached thereto.

Next, in step S1012, the CPU 1 starts the storage device monitoring processing if such processing has not been started. This storage device monitoring processing corresponds to the storage device monitoring step 209 illustrated in FIG. 2. If the processing illustrated in FIG. 15 is executed for the first time, the storage device monitoring processing has not been started. However, from the second execution and onwards, such storage device monitoring processing may already be being executed. In such a case, to avoid the same processing from being started twice, the CPU 1 controls the processing so that it is started only in necessary cases. Subsequently, the processing ends.

Then, on the multifunction peripheral 206 side, the processing of steps S808 and 809 illustrated in FIG. 12 is executed, so that the USB configuration is as designated in FIG. 16. Next, the OS (not illustrated) running on the computer 201 checks the temporary region of the external memory 11 by the plug and play function, whereby the inf file of the driver set in step S1003 is detected. As a result, only the device driver selected by the user is installed ready for use.

On the other hand, in step S1005, if the CPU 1 determines that the device driver has not been selected (NO in step S1005), the processing proceeds to step S1013. Step S1013 is processing for when a device driver has not been selected on the screen illustrated in FIG. 16, or when the cancel button 1207 has been pressed. Accordingly, to reconfirm the user's intention to finish the processing without selecting a device driver, the processing finish confirmation screen illustrated in FIG. 19 is displayed on the display 10. This allows the instruction to be determined based on the user's determination.

FIG. 19 illustrates an example of a user interface which is displayed on the display 10 illustrated in FIG. 1. This example is an example of a screen 2101 for confirming with the user whether to finish the processing.

In FIG. 19, the user presses a cancel button 2102 on the screen 2101 when he/she does not want to end processing, and presses an OK button 2103 when he/she wants to end processing.

This is just one example, and the present exemplary embodiment is not limited to this screen. Thus, if the CPU 1 determines that the OK button 2103 for finishing the processing is pressed (YES in step S1013), the processing ends.

On the other hand, in step S1013, if the CPU 1 determines that the cancel button 2102 for not finishing the processing is pressed (NO in step S1013), the processing returns to step S1004. Then, once again, the processing displays a menu screen, such as the example illustrated in FIG. 16, on the display 10, and has the user of the computer 201 select the device driver which he/she wishes to use.

On the other hand, in step S1007, if the CPU 1 determines that, as a result of checking for the presence of the storage device after generation of the device configuration data, the storage device is not present (NO in step S1007), the processing proceeds to step S1014. In step S1014, to correctly advance the processing of the device configuration data, a screen, such as the example illustrated in FIG. 18, for prompting the user of the computer 201 with a request to connect the USB cable to the multifunction peripheral 206 is displayed on the display 10. The USB cable referred to here is the two-way interface 21 illustrated in FIG. 1.

Then, in step S1015, as a result of asking the user for an instruction, the CPU 1 determines whether the user is pressing the cancel button 2002 for instructing the processing to finish on the screen illustrated in FIG. 18 displayed on the display 10 in step S1014. If the CPU 1 determines that the cancel button 2002 is pressed by the user (YES in step S1015), the processing ends.

On the other hand, in step S1015, if the CPU 1 determines that the cancel button 2002 is not pressed by the user (NO in step S1015), the processing returns to step S1007 and performs processing for confirmation of the presence of the storage device. Namely, if the user connected the USB cable corresponding to the two-way interface 21 without finishing the processing, the processing returns to step S1007 and performs processing for confirmation of the presence of the storage device.

As described above, the device configuration data can be generated and stored in the storage device (RAM 19) of the multifunction peripheral 206 by the series of processing steps illustrated in FIG. 15. Then, the reconfiguration processing of the USB is performed by the multifunction peripheral 206. As a result, plug and play occurs, and the device driver designated at the user interface illustrated in FIG. 16 is installed in the OS ready for use.

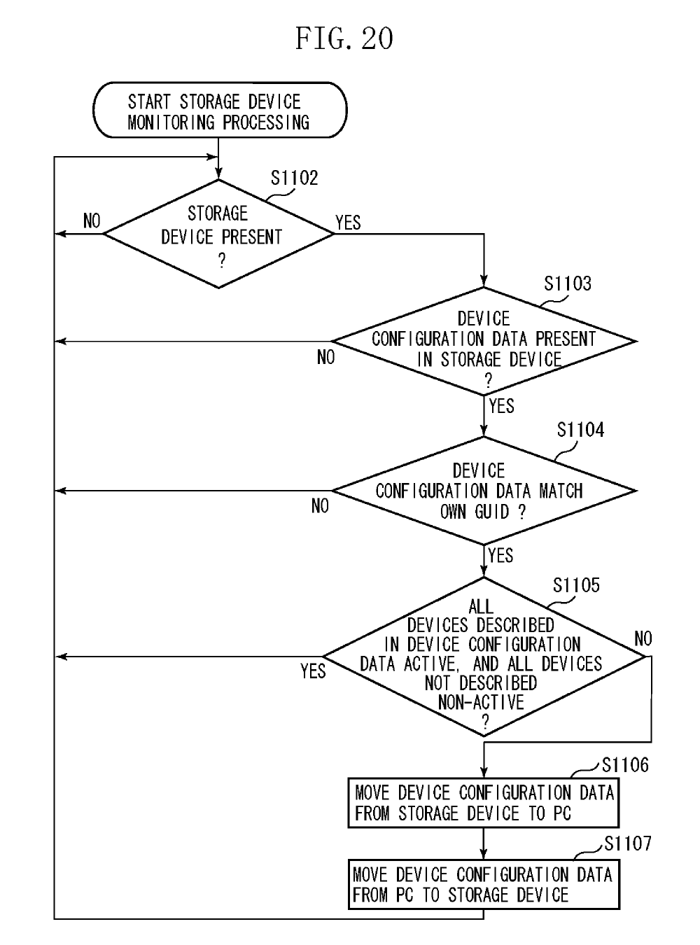

FIG. 20 is a flowchart illustrating an example of a data processing procedure in the information processing apparatus according to an exemplary embodiment of the present invention. This example is an example of processing corresponding to the storage device monitoring step 209, in which the presence of the storage device (part of the RAM 19) of the multifunction peripheral 206 is monitored and the contents of such storage device are checked. Each step is realized by the CPU 12 executing a program stored in the external memory 11 present in the computer 201.

The CPU 1 of the computer 201 starts the storage device monitoring processing which is on the external memory 11. Then, in step S1102, the CPU 1 confirms whether the storage device (part of the RAM 19) of the multifunction peripheral 206 can be viewed as an external memory 11 from the computer 201. If the CPU 1 determines that that the storage device is not present (NO in step S1102), namely, that the storage device cannot be viewed as the external memory 11 from the computer 201, the processing returns to step S1102, and the CPU 1 again confirms whether the storage device is present. Optionally, the processing may be controlled so that a suitable time gap is inserted before returning to step S1102 so as not to waste the capabilities of the CPU 1 of FIG. 1.

On the other hand, if the CPU 1 determines that that the storage device is present (YES in step S1102), the processing proceeds to step S1103. In step S1103, the CPU 1 confirms whether device configuration data is present in the found storage device. The CPU 1 performs this confirmation by a suitable method based on the format of the device configuration data.

In the description of FIG. 15, a storage method has been described in which a non-display attribute and a read-only attribute are attached to the device configuration data using its own GUID as the file name, for example the name GUID.guid. Similarly, a method for storing with the file name DeviceCFG01.cfg has been described, like in the example illustrated by device configuration data 1804 illustrated in FIG. 13.

Therefore, in step S1103, based on either of the above-described formats, the CPU 1 confirms by the optimum method whether the device configuration data is present. If the CPU 1 determines that the device configuration data is not present (NO in step S1103), the processing returns to step S1102, and the CPU 1 again checks for the presence of the storage device.

On the other hand, in step S1103, if the CPU 1 determines that the device configuration data is present (YES in step S1103), the processing proceeds to step S1104. In step S1104, the CPU 1 determines whether the device configuration data found in the storage device matches its own GUID. If the CPU 1 determines that the device configuration data does not match its own GUID (NO in step S1104), the processing returns to step S1102, and the CPU 1 again checks for the presence of the storage device.

On the other hand, in step S1104, if the CPU 1 determines that the device configuration data found in the storage device matches its own GUID (YES in step S1103), the processing proceeds to step S1105.

In step S1105, since the device configuration data matches its own GUID, the CPU 1 determines whether all of the devices described in the device configuration data are active, and all of the devices not described in the device configuration data are non-active. If the CPU 1 determines that all of the devices described in the device configuration data are active, and all of the devices not described in the device configuration data are non-active (YES in step S1105), the processing returns to step S1102, since device reconfiguration processing is not necessary.

On the other hand, in step S1105, if the CPU 1 determines that not all of the described devices are active, or that not all of the not-described devices in the device configuration data are non-active (NO in step S1105), the device configuration data needs to be reconfigured, so the processing proceeds to step S1106. In FIG. 20, examples of cases where the processing proceeds to step S1106 include a case where, after the device configuration data has been generated and the configuration of the multifunction peripheral 206 has been determined, the USB cable has been unplugged and re-connected. Another case would be where the presence of the storage device is again confirmed when the computer 201 power is again turned on.

In step S1106, the device configuration data with its own GUID is once moved to the computer 201 from the storage device of the multifunction peripheral 206. Since the present processing is for moving the device configuration data to a memory in the information processing apparatus, such as the RAM 2 or the external memory 11, the device configuration data with its own GUID is deleted from its original location (the RAM 19 of the multifunction peripheral 206).

By thus deleting the device configuration data with its own GUID from the storage device of the multifunction peripheral 206, the USB/storage device confirmation processing of step S802 illustrated in FIG. 12 can be reset. Further, by again adding the device configuration data with its own GUID into the storage device, step S802 illustrated in FIG. 8 can detect that a new item has been stored in the storage device.

Next, in step S1107, the device configuration data with its own GUID, which has been once moved to a memory of the computer 201, is again moved to the storage device of the multifunction peripheral 206, and the processing returns to step S1102. From this processing, the fact that a new item has been stored in the storage device of the multifunction peripheral 206 is detected in step S802 illustrated in FIG. 12, device reconfiguration processing is executed, and the USB configuration turns into the format illustrated in the device configuration file.

There is no end in the flow illustrated in FIG. 20. The reason why there is no end in this flow is that from the point when the processing is first started on the computer 201, the processing continues without finishing as long as the 201 is operating.

Further, even if the computer 201 is shut down and restarted, this processing continues without finishing from after the restart, so that there is still no end in the flow.

Based on the above, in a system having a USB/storage device monitoring step and a device reconfiguration step on a multifunction peripheral 206, and having a device configuration data generation step and a storage device monitoring step on a client computer, the devices desired by the user can be configured ready for use. Further, this configuration processing can be performed by an operation on the client computer, and not an operation by an operation unit on the multifunction peripheral.

Furthermore, there are cases where a connected USB cable is unplugged for some reason, and then the same client computer is reconnected to the multifunction peripheral via the USB cable. In such a case, by referencing device configuration data stored in a storage unit, the device configuration can be automatically returned each time to the originally-configured device configuration. In addition, when using the multifunction peripheral while switching the USB cable among a plurality of computers, the device configuration can be changed so as to be applicable to the connected computer.

Moreover, when the user purchases a multifunction peripheral and then immediately connects a USB cable to the client computer without installing the drivers, only a storage device whose device driver the OS would normally have become active. As a result, the occurrence of unknown devices can be eliminated.

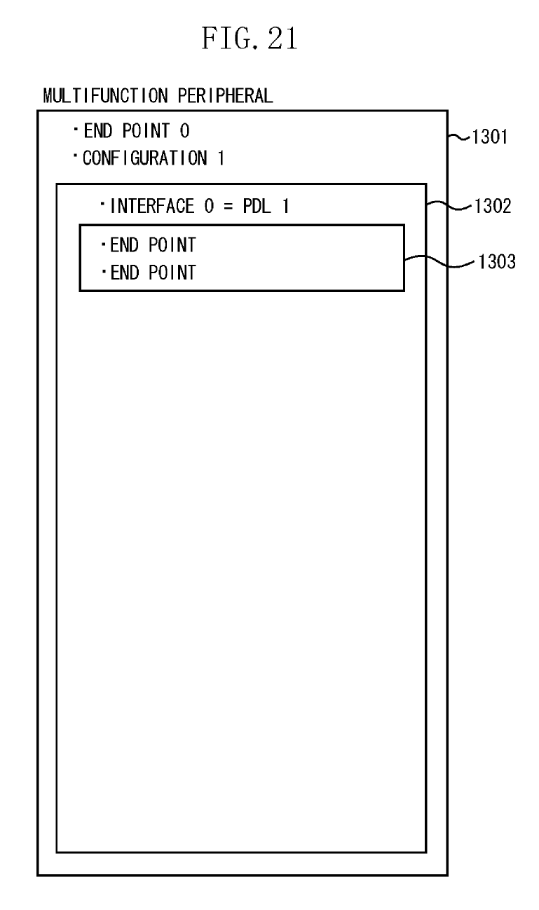

FIG. 21 illustrates a composite USB configuration in the image forming apparatus according to a second exemplary embodiment of the present invention.

The example illustrated in FIG. 21 includes a composite USB 1301 of the whole multifunction peripheral 206, a configuration 1302, and an interface 1303 which is in the configuration 1302. This interface 1303 is an element configuring the multifunction device. In FIG. 21, the interface 1303 indicates a PDL 1 device.

Thus, in this example, as illustrated by the user interface 1903 illustrated in FIG. 11, one printer icon 1904 corresponding to one PDL is generated. Here, the printer icon 1904 corresponds to the PDL 1.

Compared with the configuration illustrated in FIG. 10, the present example is characterized in that there is no storage device in the composite USB illustrated in FIG. 21. This interface combination is just one example. As long as the configuration is formed from a separate combination of the interfaces illustrated in FIG. 8 other than the storage device, any combination may be used without a problem.

In the second exemplary embodiment also, the configuration during product shipment and when the USB cable between the multifunction peripheral 206 and the computer 201 has been unplugged to release the connection consists of the multifunction peripheral 206 illustrated in FIG. 9 in which only one storage device is present.

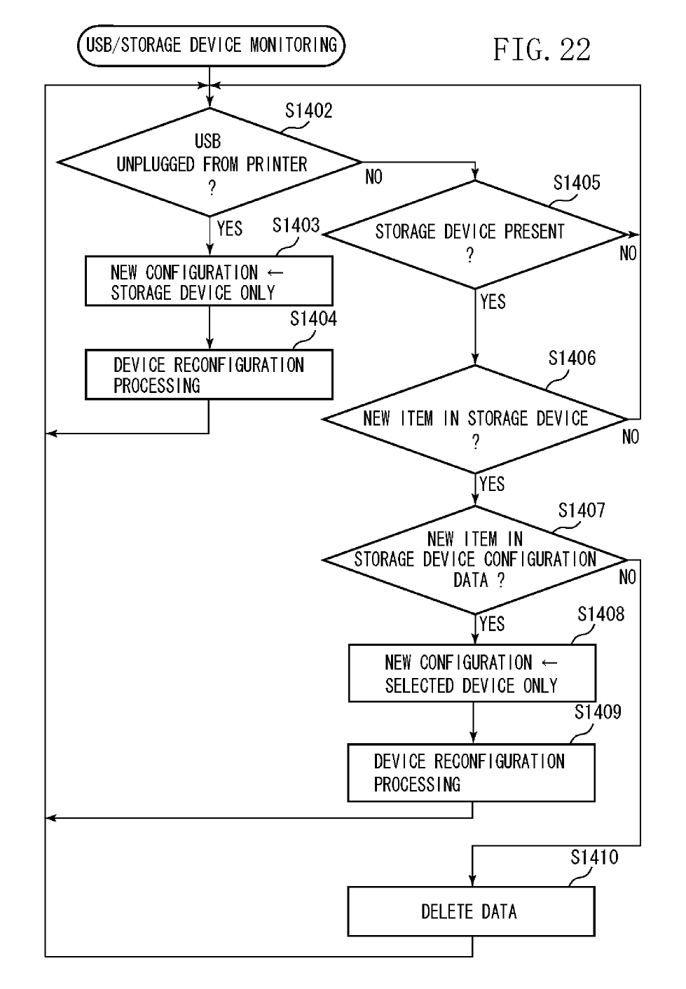

FIG. 22 is a flowchart illustrating a data processing procedure in the image forming apparatus according to an exemplary embodiment of the present invention. This example is a processing example of monitoring the connection state of the USB cable (corresponding to the two-way interface 21 illustrated in FIG. 1), and monitoring the state of the storage device assigned as the RAM 19. Each step is realized by the CPU 12 executing a program stored in the program ROM of the ROM 13 present in the multifunction peripheral 206 illustrated in FIG. 1 or in the external memory 14. Here, “storage device” refers to the storage device managed by the interface 603 corresponding to the interface 0 illustrated in FIG. 9. Specifically, the storage device is configured utilizing a part of the RAM 19 of FIG. 1.

This storage device can be viewed as a type of external memory 11 which utilizes a function of the OS (not illustrated) from the computer 201 illustrated in FIG. 1.

If the USB/storage device monitoring processing is started, then in step S1402, the CPU 12 checks whether the USB cable (corresponding to the two-way interface 21 illustrated in FIG. 1) has been unplugged from the multifunction peripheral 206. If the CPU 12 determines that a connected USB cable has been unplugged (YES in step S1402), the processing proceeds to step S1403. If the CPU 12 determines that there is no change in the state (NO in step S1402), the processing proceeds to step S1405. The expression “no change in the state” refers to a case where an unplugged USB cable remains unplugged, or where a connected USB cable remains connected.

In step S1403, since the connected USB cable has been unplugged, the new device configuration should only be the storage device, and thus the CPU 12 sets the new configuration as storage device only. Then, in step S1404, the CPU 12 moves control to the processing for device reconfiguration for updating the device configuration.

Once the device reconfiguration processing ends by the CPU 12, the processing returns to step S1402, and whether there is any change in the state of the USB cable is again monitored. As described above, in step S1402, if there is no change in the connection state of the USB cable because it is already unplugged, the CPU 12 does not determine that the USB cable has been unplugged. The CPU 12 determines that the USB cable has been unplugged only if the USB cable has been connected when the determination in step S1402 has been made and then has been subsequently unplugged.

On the other hand, if the CPU 12 determines in step S1402 that the USB cable has not been unplugged (NO in step S1402), the processing proceeds to step S1405. In the second exemplary embodiment, because a state where the storage device is not present is possible, this state is checked first.

Specifically, the CPU 12 confirms the USB configuration on the multifunction peripheral 206 (FIGS. 9 and 21), and confirms whether the storage device is active or not. If the CPU 12 determines that the storage device is active (YES in step S1405), the processing proceeds to step S1406. If the CPU 12 determines that the storage device is not active (NO in step S1405), the processing returns to step S1402.

In step S1406, the CPU 12 determines whether a new item has been stored in the storage device. Here too, the CPU 12 monitors state changes in the same manner as in step S1402. In step S1406, if the CPU 12 determines that there is no change in the state (case where the stored items remain as is), the CPU 12 does not determine that a new item has been stored.

On the other hand, when a new item is newly added to the storage device, or when an already-stored item is deleted and then stored again in the storage device, the CPU 12 determines that a new item has been stored in the storage device.

If the CPU 12 determines that a new item has been stored (YES in step S1406), the processing proceeds to step S1407. If the CPU 12 determines that a new item has not been stored (NO in step S1406), the processing returns to step S1402. The CPU 12 may optionally control the processing so that a suitable time gap is inserted before returning to step S1402 so as not to waste the capabilities of the CPU 12.

In step S1407, the CPU 12 determines whether the data newly stored in the storage device is the above-described device configuration data illustrated in FIG. 13 acquired from the computer 201. The determination method is the same as in the first exemplary embodiment, and thus the description thereof is omitted here.

If the CPU 12 determines that the newly stored data is device configuration data (YES in step S1407), the processing proceeds to step S1408. If the CPU 12 determines that the newly stored data is not device configuration data (NO in step S1407), the processing proceeds to step S1410.

In step S1408, the new device configuration should only be the selected device configuration data, and thus the CPU 12 sets the new configuration as the selected device configuration data. Then, in step S1410, the processing moves control to the device reconfiguration processing for updating the device configuration. In the present exemplary embodiment, since the storage device is deleted after the device reconfiguration processing of step S1409, the device configuration data added into the storage device also simultaneously deleted. When the device reconfiguration processing ends, the processing proceeds to step S1402, and the CPU 12 again monitors whether there is any change in the state of the USB cable.

As described above, in step S1402, if the USB cable has already been unplugged, so that there has been no change in its state, the CPU 12 does not determine that the USB cable has been unplugged. The CPU 12 determines that the USB cable has been unplugged only if the USB cable has been connected when the determination in step S1402 has been made, and then has been subsequently unplugged.

On the other hand, if the CPU 12 determines that the newly stored data is not device configuration data (NO in step S1407), when the processing proceeds to step S1410, it is apparent that the data acquired from the computer 201 is not device configuration data.

In the present exemplary embodiment, since the data which is received by the storage device of the RAM 19 is device configuration data, in this case the data stored in the storage device is data that cannot be processed.

Therefore, in step S1410, the CPU 12 simply deletes the data stored in the storage device, the processing returns to step S1402, and the CPU 12 again monitors whether there is any change in the USB cable state.

From the point when the multifunction peripheral 206 is started, the flow of FIG. 14 is set in motion. Therefore, so that as long as the device is operating, the processing continues without finishing, meaning that there is no end in the flow illustrated in FIG. 22.

As described above, in the present exemplary embodiment, in the processing illustrated in FIG. 22, when the USB connection is disconnected, the configuration can be changed to a storage device only device. Further, the configuration can also be changed to devices based on an instruction about the device configuration data added to the storage device.

Further, data other than the device configuration data added into the storage device can be deleted and ignored.

Further, the device reconfiguration processing illustrated in FIG. 14 is effective as is even in the second exemplary embodiment. This means that the devices can be reconfigured to a device configuration based on the new configuration. A detailed description thereof will not be repeated here.

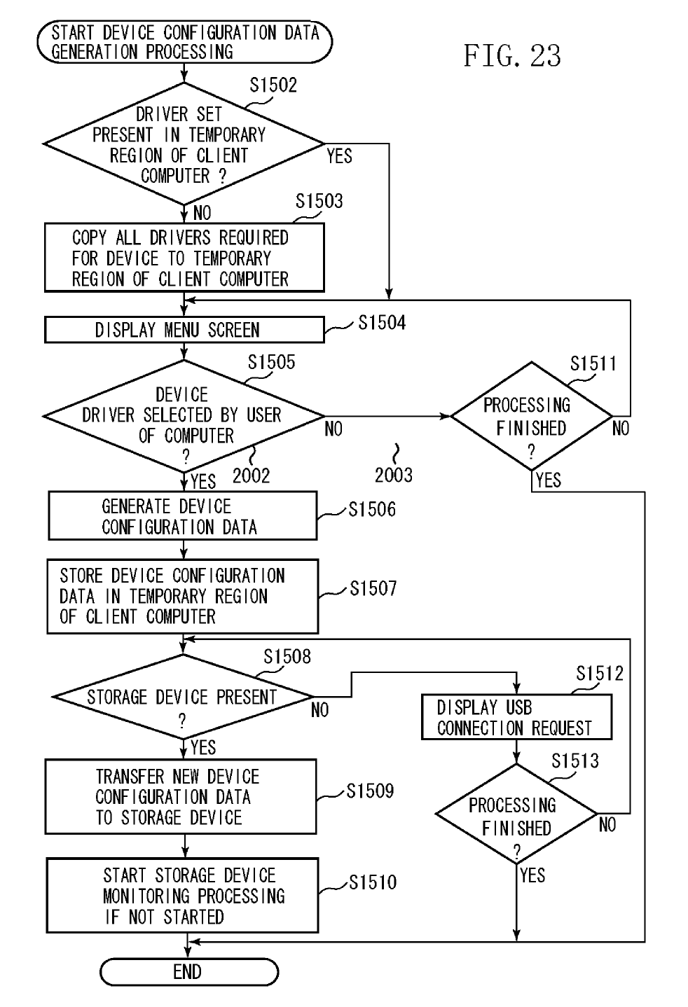

FIG. 23 is a flowchart illustrating an example of a data processing procedure in the information processing apparatus according to an exemplary embodiment of the present invention. This example is a processing example in which device configuration data is generated and stored in the storage device (RAM 19) when installing the device driver into the multifunction peripheral 206. Each step is realized by the CPU 1 executing a program stored in the external memory 11 present in the computer 201. The difference with the processing illustrated in FIG. 15 is that the generated device configuration data is temporarily stored in the computer 201, the presence of the storage device is checked, and then the device configuration data is transferred to the multifunction peripheral 206.

The present processing starts when the CPU 1 starts the driver installation program 2301 illustrated in FIG. 5, which is stored in the external memory 11 of the computer 201, such as a CD, HDD, or memory device.

First, in step S1502, the CPU 1 determines whether a driver set is present in a temporary region of the external memory 11 of the computer 201. This temporary region of the external memory 11 is a region in which the presence of the inf file is confirmed from the OS (not illustrated) of the computer 201 during plug and play. If the CPU 1 determines that a driver set is present (YES in step S1502), the processing proceeds to step S1504. If the CPU 1 determines that a driver set is not present (NO in step S1502), the processing proceeds to step S1503.

Here, while step S1503 is skipped if a driver set is already present, step S1503 may be mandatorily executed without performing this determination. This type of processing is effective, for example, in order to use a new version of a driver when a different version of the driver is acquired.

In step S1503, the driver program in the external memory 11 of the computer 201, such as a CD, HDD, or memory device, is copied to a temporary region of the external memory 11. Performing this processing allows a search for the inf file to be carried out from the OS when the plug and play is subsequently performed.

Next, in step S1504, the CPU 1 displays a menu screen, such as the example illustrated in FIG. 16, on the display 10, and the user of the computer 201 selects the device driver he/she wishes to use. The screen illustrated in FIG. 16 displayed on the display 10 is effective as is even in the second exemplary embodiment.

Then, in step S1505, the CPU 1 determines whether a device driver has been selected on the screen illustrated in FIG. 16. Here, the conditions that the device driver has been selected are that the OK button 1208 is pressed based on a user operation on the screen illustrated in FIG. 16, and that a check box of one or more of the check items from among the check items 1202 to 1206 illustrated in FIG. 16 is checked. If these conditions are satisfied (YES in step S1505), the processing proceeds to step S1506.

On the other hand, if the CPU 1 determines that the following conditions are satisfied, it is determined that a device driver has not been selected. Specifically, in FIG. 16, that a check box corresponding to any of the check items from among the check items 1202 to 1206 is not checked, and that the cancel button 1207 is pressed based on a user operation on the screen illustrated in FIG. 16. If the CPU 1 determines that these conditions are satisfied, it is determined that a device driver has not been selected (NO in step S1505), and the processing proceeds to step S1511.

In step S1506, based on the check item which has been selected by the user on the menu screen 1201 illustrated in FIG. 16, the device configuration data 1803 illustrated in FIG. 13 is generated by the CPU 1 executing the device configuration data generation step 208.

In step S1507, the device configuration data generated by the CPU 1 is temporarily stored in a region on the external memory 11 of the computer 201. Here, while the device configuration data has been temporarily stored in a region on the external memory 11, the device configuration data is not referenced by plug and play. Therefore, as long as the same location can be referenced when subsequently referenced, another location other than a region on the external memory 11 may be used.

In step S1008, the CPU 1 checks for the presence of the storage device of the multifunction peripheral 206. When viewed from the computer 201, the storage device (part of the RAM 19) of the multifunction peripheral 206 can be viewed as if it is an external memory 11. Here, an example of a method for checking for the presence of the storage device is to pre-store a non-display attribute storage device recognition tag file (file 2202 in FIG. 17) in the storage device, then successively check the plurality of present external memories 11 as the system, and recognize the device with this storage device recognition tag file as the storage device of the multifunction peripheral 206.

As another example of such method, a character string which is predetermined as a storage device volume name is embedded in the storage device, and the device whose character string is the volume name 2204 illustrated in FIG. 17 is recognized as the storage device of the multifunction peripheral 206. This determination method is the same as in the first exemplary embodiment, and thus a description thereof is not repeated here.

In step S1508, as a result of checking for the presence of the storage device, if the CPU 1 determines that the storage device is not present (NO in step S1508), there is a possibility that the computer 201 and the multifunction peripheral 206 are not connected by the USB cable. Therefore, the processing proceeds to step S1512, in which the screen 2001 illustrated in FIG. 18 is displayed to prompt connection.

On the other hand, in step S1508, if the CPU 1 determines that the storage device is present (YES in step S1008), the processing proceeds to step S1509. In step S1509, the CPU 1 transfers the device configuration data generated based on the new configuration to the storage device of the multifunction peripheral 206 via the two-way interface 21. At this point, like the device configuration data illustrated as an example in FIG. 13, a non-display attribute and a read-only attribute are attached to the device configuration data using its own GUID as the file name, for example, the name GUID.guid, and the resultant device configuration data is stored. The device configuration data 1803 and 1804 illustrated in FIG. 13 are as described in the first exemplary embodiment.

The reason for attaching the non-display attribute is that the contents of the storage device can be easily referenced, due to the fact that the storage device of the multifunction peripheral 206 can be viewed on the computer 201 as a part of the external memory 11. Namely, the non-display attribute is also attached to prevent inadvertent correction by the user. In addition, since the device configuration disappears if the device configuration data is deleted, the read-only attribute is also attached to prevent inadvertent deletion.

As a result, in the multifunction peripheral 206, the file has a file name extension “.guid,” which allows the file to be identified as device configuration data.

Further, the GUID portion before the extension is used to identify the fact that such portion is data that has been generated by the computer 201 itself.

In the top line in the file, 0x00, 0x01, 0x03, 0x04, 0x05, 0x06, 0x07, 0x08, 0x09 is described. This indicates that the file configured from these several bytes is device configuration data. The value and the length are not limited to this example, and may be an arbitrary value and length as long as they are thought to be capable of uniquely identifying the file contents.

Further, while the GUID has been used for the file name and .guid for the extension to identify the file as being device configuration data, the file extension is not limited to this.

Moreover, a configuration that does not use the GUID for the file name of the device configuration data may be employed, and the example illustrated by device configuration data 1804 illustrated as an example in FIG. 13 may also be employed. The configuration of the device configuration data 1804 is the same as in the first exemplary embodiment. Further, for the same reasons as described above, in this example too, the file may be stored with a non-display attribute and a read-only attribute attached thereto.

Next, in step S1510, the CPU 1 starts the storage device monitoring processing (corresponding to storage device monitoring step 209) if such processing has not been started. If the processing illustrated in FIG. 23 is executed for the first time, the storage device monitoring processing has not been started. However, from the second execution and onwards, such storage device monitoring processing may already be being executed. In such a case, to avoid the same processing from being started up twice, the CPU 1 controls the processing so that it is started only in necessary cases. Subsequently, the processing ends.

Then, on the multifunction peripheral 206 side, the processing of steps S1408 and 1409 illustrated in FIG. 22 is executed, so that the USB configuration is as designated in FIG. 16. Next, the OS (not illustrated) running on the computer 201 checks the temporary region of the external memory 11 by the plug and play function, whereby the inf file of the driver set the temporary region of the external memory 11 is detected. As a result, only the device driver selected by the user is installed ready for use.

On the other hand, in step S1505, if the CPU 1 determines that the device driver is not selected on the screen illustrated in FIG. 16 (NO in step S1505), the processing proceeds to step S1511. In step S1511, to reconfirm the user's intention to finish the processing without selecting a device driver, the CPU 1 displays the processing finish confirmation screen illustrated as an example in FIG. 19 on the display 10. The processing then waits for an instruction based on the user's determination.

If the CPU 1 determines that the OK button 2103 in the screen illustrated in FIG. 19 is pressed, the processing ends.

On the other hand, in step S1511, if the CPU 1 determines that the cancel button 2102 in the screen illustrated in FIG. 19 is pressed, the processing returns to step S1504 without finishing, and a menu screen like that illustrated in as an example in FIG. 16 is displayed on the display 10. Then, the processing has the user of the computer 201 select on the screen illustrated in FIG. 16 the device driver that he/she wishes to use.

On the other hand, in step S1508, if the CPU 1 determines that, as a result of checking for the presence of the storage device after generation of the device configuration data, the storage device is not present (NO in step S1508), the processing proceeds to step S1512. In step S1512, to correctly advance the processing of the device configuration data, the CPU 1 displays a screen, such as the example illustrated in FIG. 18, for notifying the user of an instruction to connect the USB cable (two-way interface 21 in FIG. 1). The user of the computer 201 confirms the screen illustrated in FIG. 18 to confirm that the USB cable (two-way interface 21 in FIG. 1) needs to be connected to the multifunction peripheral 206.

Then, in step S1513, the CPU 1 determines whether the user is pressing the cancel button 2002 for instructing the processing to finish on the screen illustrated as an example in FIG. 18 displayed in step S1512. If the CPU 1 determines that the cancel button 2002 is pressed by the user (YES in step S1513), the processing ends.

On the other hand, if the CPU 1 determines that USB cable is connected and the OK button 2003 is pressed, the processing returns to step S1508 and performs processing for confirmation of the presence of the storage device.

As described above, in the processing in FIG. 23, the reconfiguration processing of the USB is performed by the multifunction peripheral 206 after the device configuration data is generated and stored in the storage device (RAM 19) of the multifunction peripheral 206. Then, as a result, plug and play occurs, and the device driver designated by the user at the screen illustrated in FIG. 16 is installed in the OS ready for use.

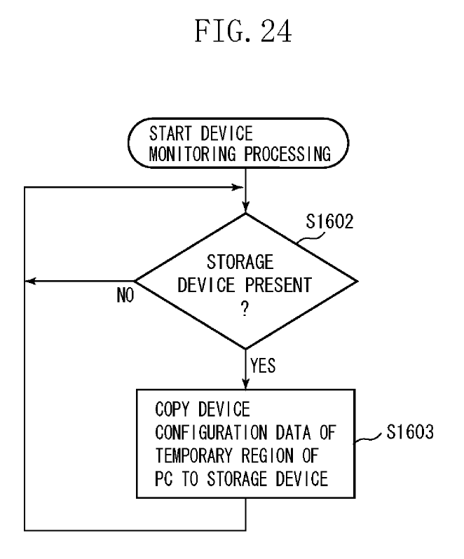

FIG. 24 is a flowchart illustrating an example of a data processing procedure in the information processing apparatus according to an exemplary embodiment of the present invention. This example is a processing example in which the presence of the storage device (part of the RAM 19) of the multifunction peripheral 206 is monitored and the contents of such storage device are checked. Each step is realized by the CPU 12 executing a program stored in the external memory 11 present in the computer 201.

First, the CPU 1 starts the storage device monitoring processing which is on the external memory 11 of the computer 201.

Then, in step S1602, the CPU 1 confirms whether the storage device (part of the RAM 19) of the multifunction peripheral 206 can be viewed as an external memory 11 from the computer 201. If the CPU 1 determines that that the storage device is not present (NO in step S1602), namely, that the storage device cannot be viewed as the external memory 11 from the computer 201, the processing returns to step S1602, and the CPU 1 again confirms whether the storage device is present. Optionally, the processing may be controlled so that a suitable time gap is inserted before returning to step S1602 so as not to waste the capabilities of the CPU 1 illustrated in FIG. 1.

On the other hand, if the CPU 1 determines that that the storage device is present (YES in step S1602), the processing proceeds to step S1603. An example of the processing proceeding to step S1103 would be where after the device configuration data is stored in the storage device and the configuration processing of the device is performed, the device configuration returns to being the storage device only as a result of the USB cable being unplugged or the like.

In the present exemplary embodiment, since the storage device is deleted when the device configuration data is generated and the device reconfiguration processing is performed, if the storage device were to appear once more, it would be apparent that there has been nothing in that storage device.

In step S1603, the CPU 1 copies the device configuration data, which is in a temporary region of the external memory 11 of the computer 201, onto the storage device of the multifunction peripheral 206, and the processing returns to step S1602. Then, the processing of steps S1408 and S1409 illustrated in FIG. 22 is performed, so that the USB configuration is as designated in FIG. 16.

There is no end in the flow illustrated in FIG. 16. The reason why there is no end in this flow is that from the point when the processing is first started on the computer 201, the processing continues without finishing as long as the 201 is operating.

Further, even if the computer 201 is shut down and restarted, this processing continues without finishing from after the restart, so that there is still no end in the flow.

In the above-described present system, the USB/storage device monitoring step 205 and the device reconfiguration step 204 are executed on the multifunction peripheral 206. On the other hand, the device configuration data generation step 208 and the storage device monitoring step 209 are executed on the computer 201. Thus, when the device is connected to the information processing apparatus, the user can install a device driver from among a plurality of device drivers that can be installed, so that the desired device is ready for use.

Further, the processing in which the configuration is selected by the user can be performed via the user interface on the computer, and not by an operation of the operation unit of the multifunction peripheral.

Furthermore, when reconnecting the USB cable to the same client computer, the device configuration can be automatically returned each time to the originally-configured device configuration. In addition, when using and switching the USB cable among a plurality of client computers, the device configuration of the USB cable can be changed based on the configuration of the connecting client computer.

Moreover, even if a multifunction peripheral is connected immediately after being purchased to the client computer without installing the drivers, only the storage device whose device driver the OS would normally have become active. As a result, the occurrence of unknown devices is eliminated.

Although not illustrated, information for managing a group of programs stored in a storage medium, for example, version information and the creator, and information that depends on the OS of the program reading side, for example, an icon identifying and displaying a program, can also be stored.

Further, data subordinate to various programs is also managed in a directory. In addition, programs for installing the various programs on a computer, and in the case where a program to be installed is compressed, programs for extracting can also be stored.

The functions in the present exemplary embodiments can be performed by a host computer using a program which is externally installed. In that case, the present invention can still be applied in cases where information groups including a program are supplied to an output apparatus by a storage medium such as a compact disc read-only memory (CD-ROM), a flash memory, or a floppy disk, or from an external storage medium via a network.

Thus, a storage medium, on which the software program code for realizing the functions of the above exemplary embodiments is stored, is supplied to a system or an apparatus. Further, the present invention is achieved by having a computer (or a CPU or a micro processing unit (MPU)) of the system or apparatus read and execute the program code stored on the storage medium.

In this case, the program code itself read from the storage medium realizes the novel functions of the present invention, so that the storage medium which stores the program code constitutes another embodiment of the present invention.

Therefore, the type of the program is not limited so long as it has the function of a program, and can be object code, a program executed by an interpreter, script data supplied to the OS, and the like.

Examples of storage media for supplying the program include a floppy disk, a hard disk, an optical disc, a magneto optical disk (MO), a CD-ROM, a compact disc recordable (CD-R), a CD-rewritable (CD-RW), a magnetic tape, a non-volatile memory, a ROM, a digital versatile disc (DVD), and the like.

In this case, the program code itself, which is read from the storage medium, implements the functions of the above exemplary embodiments, and thus the storage medium on which such program code is stored constitutes an embodiment of the present invention.

The method for supplying the program includes accessing a website on the Internet using the browsing function of a client computer, when the website allows each user to download the computer program according to the exemplary embodiments of the present invention, or compressed files of the programs having automatic installing functions, to a hard disk or other storage medium of the user. Furthermore, the program code constituting the programs according to the exemplary embodiments of the present invention can be divided into a plurality of files so that respective files are downloadable from different websites. Namely, the present invention encompasses World Wide Web (WWW) servers and File Transfer Protocol (FTP) servers that allow numerous users to download the program files so that their computers can realize the functions and processes according to the exemplary embodiments of the present invention.

Further, the program of the exemplary embodiments of the present invention can be encrypted, stored on a storage medium such as a CD-ROM, and distributed to a user. A user satisfying certain conditions is allowed to download key information for deciphering the encrypted information from a website via the Internet. By using that key information, the user can decipher the encrypted program, and can install the program on a computer to realize the functions of the exemplary embodiments.

Further, the present invention also includes embodiments where, for example, based on an instruction from that program code, the OS or the like running on the computer performs part or all of the actual processing, and by that processing the functions of the above-described exemplary embodiments are realized.

In addition, the present invention also includes cases where the program code read from a storage medium is written into a memory of a function expansion board inserted into the computer or a function expansion unit connected to the computer. Then, based on an instruction from the program code, a CPU or the like provided on the function expansion board or function expansion unit performs part or all of the actual processing. By that processing, the functions of the above-described exemplary embodiments are realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-200653 filed Aug. 4, 2008, which is hereby incorporated by reference herein in its entirety.

What is claimed is:

1. An image forming apparatus including a plurality of functions corresponding respectively to a plurality of device drivers, the image forming apparatus comprising:
a communication unit configured to communicate with an information processing apparatus according to a universal serial bus standard;
a storage unit corresponding to a storage class defined by the universal serial bus standard;
a determination unit configured to determine whether device information corresponding to one function among the plurality of functions has been received from the information processing apparatus; and
a sending unit configured to, if the determination unit determines that the device information has been received, send information based on the device information to the information processing apparatus via the communication unit.

2. The image forming apparatus according to claim 1, further comprising a resetting unit configured to reset device information stored by the storage unit according to a change in a communication state of the communication unit.

3. The image forming apparatus according to claim 2, wherein when the communication state of the communication unit has changed from a non-communication state to a communication state and then has changed from the communication state to the non-communication state, the resetting unit resets the device information stored by the storage unit.

4. The image forming apparatus according to claim 1, wherein when the resetting unit resets the device information, the resetting unit applies a non-display attribute to the device information stored by the storage unit.

5. The image forming apparatus according to claim 1, wherein the device information includes identification information for identifying an operating system of the information processing apparatus.

6. The image forming apparatus according to claim 5, wherein the identification information is generated based on a predetermined pseudorandom number.

7. An information processing apparatus capable of communicating with an image forming apparatus and including a plurality of device drivers for controlling a plurality of functions of the image forming apparatus, the information processing apparatus comprising:
a selection unit configured to select a device driver to be used from among the plurality of device drivers;
a transfer unit configured to transfer device information specified by the device driver selected by the selection unit to the image forming apparatus to store the transferred device information in the image forming apparatus; and
an installation unit configured to install one device driver from among the plurality of device drivers using information transferred from the image forming apparatus based on the device information.

8. The information processing apparatus according to claim 7, further comprising:
a determination unit configured to determine whether device information is stored in the image forming apparatus; and
a deletion unit configured to delete the device information when the determination unit determines that the device information is stored in the image forming apparatus,
wherein the transfer unit is configured to, after deletion by the deletion unit, transfer device information different from the deleted device information to the image forming apparatus.

9. The information processing apparatus according to claim 7, wherein the device information includes identification information for identifying an operating system of the information processing apparatus.

10. The information processing apparatus according to claim 9, wherein the identification information is generated based on a predetermined pseudorandom number.

11. A method for controlling an image forming apparatus including a plurality of functions corresponding respectively to a plurality of device drivers, the method comprising:
communicating with an information processing apparatus according to a universal serial bus standard;
storing a storage class defined by the universal serial bus standard;
determining whether device information corresponding to one function among the plurality of functions has been received from the information processing apparatus; and
sending, when it is determined that the device information has been received, information based on the device information to the information processing apparatus.

12. A method for controlling an information processing apparatus capable of communicating with an image forming apparatus and including a plurality of device drivers for controlling a plurality of functions of the image forming apparatus, the method comprising:
selecting a device driver to be used from among the plurality of device drivers;
transferring device information specified by the selected device to the image forming apparatus to store the transferred device information in the image forming apparatus; and
installing one device driver from among the plurality of device drivers using information transferred from the image forming apparatus based on the device information.

13. A computable-readable storage medium storing a control program for causing a computer to execute a method for controlling an image forming apparatus including a plurality of functions corresponding respectively to a plurality of device drivers, the method comprising:
communicating with an information processing apparatus according to a universal serial bus standard;
storing a storage class defined by the universal serial bus standard;
determining whether device information corresponding to one function among the plurality of functions has been received from the information processing apparatus; and
sending, when it is determined that the device information has been received, information based on the device information to the information processing apparatus.

14. A computable-readable storage medium storing a control program for causing a computer to execute a method for controlling an information processing apparatus capable of communicating with an image forming apparatus and including a plurality of device drivers for controlling a plurality of functions of the image forming apparatus, the method comprising:
selecting a device driver to be used from among the plurality of device drivers;
transferring device information specified by the selected device to the image forming apparatus to store the transferred device information in the image forming apparatus; and
installing one device driver from among the plurality of device drivers using information transferred from the image forming apparatus based on the device information.
